(19) United States
(12) Patent Application Publication
(10) Pub. No.: US 2024/0354805 A1
(43) Pub. Date: Oct. 24, 2024

(54) BUCKETING SYSTEM FOR FEATURE OPTIMIZATION

(71) Applicant: Yahoo Ad Tech LLC, New York, NY (US)

(72) Inventors: Amit Agarwal, Mountain House, CA (US); Sreekanth Mamidala, Montain House, CA (US); Ajit A. Bhate, Los Gatos, CA (US)

(21) Appl. No.: 18/136,913

(22) Filed: Apr. 20, 2023

(51) Int. Cl. G06Q 30/0251

(52) U.S. Cl. CPC G06Q 30/0255

(57) ABSTRACT

One or more computing devices, systems, and/or methods are provided. In an example, a first bucket associated with a first profile and/or a second bucket associated with a second profile are configured. First processes of a first evaluation period may be assigned to the first bucket. The first processes may be performed according to the first profile associated with the first bucket. Second processes of the first evaluation period may be assigned to the second bucket. The second processes may be performed according to the second profile associated with the second bucket. Evaluation metrics associated with the first bucket and the second bucket may be determined based upon the first processes and the second processes. Based upon the evaluation metrics, the first bucket may be selected to be a production bucket during a second evaluation period following the first evaluation period.

### BACKGROUND

Many services, such as websites, applications, etc. may provide platforms for viewing media. For example, a user may interact with a service. While interacting with the service, selected media may be presented to the user automatically. Some of the media may be advertisements advertising products and/or services associated with a company.

### SUMMARY

In accordance with the present disclosure, one or more computing devices and/or methods are provided. In an example, a plurality of buckets may be configured. The plurality of buckets may comprise a first bucket associated with a first profile, a second bucket associated with a second profile, and/or a third bucket associated with a third profile. A first plurality of content item requests may be assigned to the first bucket. First processes associated with the first plurality of content item requests may be performed according to the first profile associated with the first bucket. A second plurality of content item requests may be assigned to the second bucket. Second processes associated with the second plurality of content item requests may be performed according to the second profile associated with the second bucket. Evaluation metrics associated with the first bucket and the second bucket may be determined based upon the first processes and the second processes. The first bucket may be selected based upon the evaluation metrics. In response to selecting the first bucket, the third profile associated with the third bucket may be modified based upon the first profile associated with the first bucket.

In an example, a plurality of buckets may be configured. The plurality of buckets may comprise a first bucket associated with a first profile, a second bucket associated with a second profile, and/or a third bucket associated with a third profile. A first plurality of processes may be assigned to the first bucket. The first plurality of processes may be performed according to the first profile associated with the first bucket. A second plurality of processes may be assigned to the second bucket. The second plurality of processes may be performed according to the second profile associated with the second bucket. Evaluation metrics associated with the first bucket and the second bucket may be determined based upon the first plurality of processes and the second plurality of processes. The first bucket may be selected based upon the evaluation metrics. In response to selecting the first bucket, the third profile associated with the third bucket may be modified based upon the first profile associated with the first bucket.

In an example, a plurality of buckets may be configured. The plurality of buckets may comprise a first bucket associated with a first profile and/or a second bucket associated with a second profile. A first plurality of processes of a first evaluation period may be assigned to the first bucket. The first plurality of processes may be performed according to the first profile associated with the first bucket. A second plurality of processes of the first evaluation period may be assigned to the second bucket. The second plurality of processes may be performed according to the second profile associated with the second bucket. Evaluation metrics associated with the first bucket and the second bucket may be determined based upon the first plurality of processes and the second plurality of processes. Based upon the evaluation metrics, the first bucket may be selected to be a production bucket during a second evaluation period following the first evaluation period.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for implementing a plurality of buckets to evaluate one or more profiles and/or optimize one or more features.

FIG. 5A illustrates an example bucket configuration used in an example system for implementing a plurality of buckets to evaluate one or more profiles and/or optimize one or more features.

FIG. 5B is a component block diagram illustrating an example system for implementing a plurality of buckets to evaluate one or more profiles and/or optimize one or more features, where a bucketing system assigns processes to various buckets.

FIG. 5C is a component block diagram illustrating an example system for implementing a plurality of buckets to evaluate one or more profiles and/or optimize one or more features, where a bucketing system determines first bucket scores based upon first evaluation metrics.

FIG. 5D is a component block diagram illustrating an example system for implementing a plurality of buckets to evaluate one or more profiles and/or optimize one or more features, where a bucketing system assigns processes to various buckets.

FIG. 5E is a component block diagram illustrating an example system for implementing a plurality of buckets to evaluate one or more profiles and/or optimize one or more features, where a bucketing system assigns processes to various buckets.

FIG. 6A is a component block diagram illustrating an example system for providing content to client devices, where a content system receives a request associated with a client device.

FIG. 6B is a component block diagram illustrating an example system for providing content to client devices, where a content system transmits content item requests to content item servers.

FIG. 6C is a component block diagram illustrating an example system for providing content to client devices, where a content system receives responses from content item servers.

FIG. 6D is a component block diagram illustrating an example system for providing content to client devices, where a content item is presented on a first client device via a web page.

FIG. 7A illustrates an example bucket configuration used in an example system for implementing a plurality of buckets to evaluate one or more profiles and/or optimize one or more features.

FIG. 7B illustrates a timing diagram associated with running an optimization process in an example system for implementing a plurality of buckets to evaluate one or more profiles and/or optimize one or more features.

FIG. 8A is a component block diagram illustrating an example system for implementing a plurality of buckets to evaluate one or more profiles and/or optimize one or more features.

FIG. 8B is a component block diagram illustrating an example architecture associated with an example system for implementing a plurality of buckets to evaluate one or more profiles and/or optimize one or more features.

FIG. 9 illustrates example code for implementing one or more of the disclosed techniques.

FIG. 10 illustrates example code for implementing one or more of the disclosed techniques.

FIG. 11A illustrates a first portion of an example class diagram of various example classes that may be used to perform one or more of the techniques herein.

FIG. 11B illustrates a second portion of the example class diagram illustrated in FIG. 11A.

FIG. 12 illustrates example code for implementing one or more of the disclosed techniques.

FIG. 13 illustrates example code for implementing one or more of the disclosed techniques.

FIG. 14 illustrates example code for implementing one or more of the disclosed techniques.

FIG. 15 illustrates example code for implementing one or more of the disclosed techniques.

FIG. 16 illustrates example code for implementing one or more of the disclosed techniques.

FIG. 17 is a component block diagram illustrating one or more example flow diagrams associated with interactions between a client and a bucketing system.

FIG. 18 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

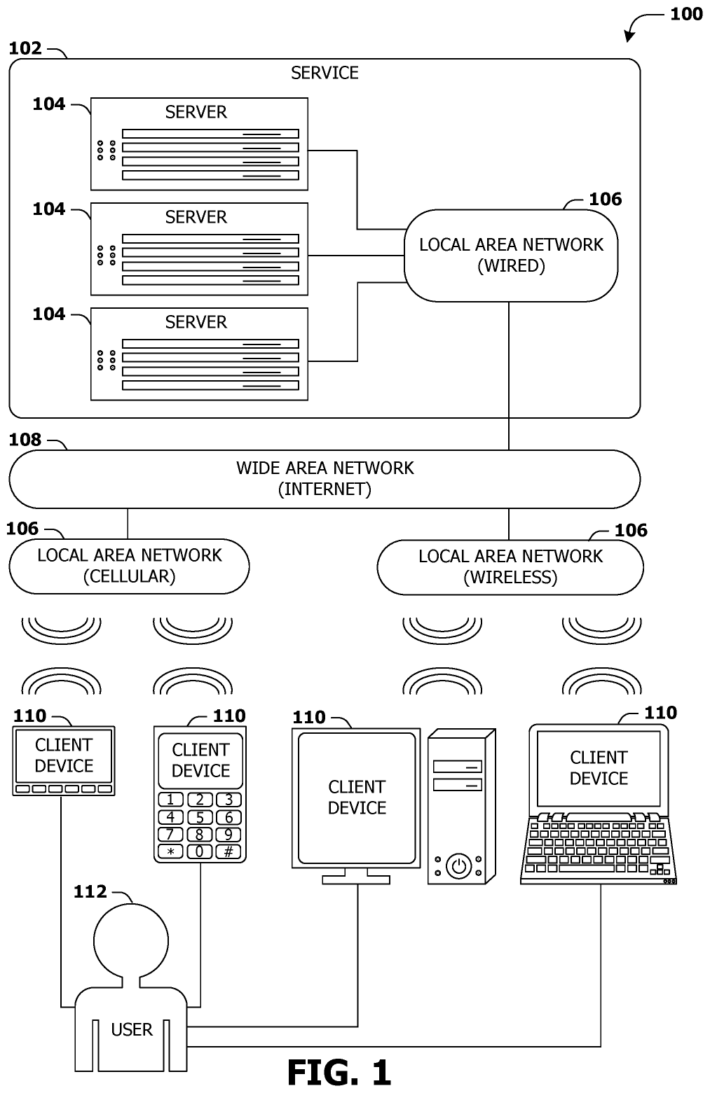

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

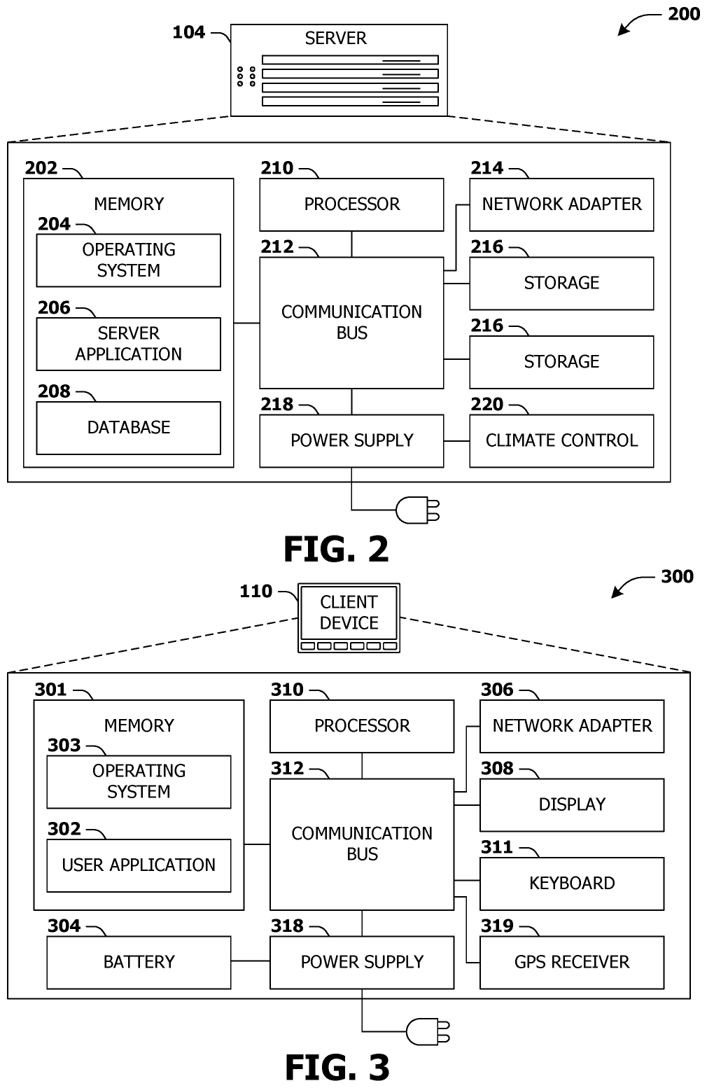

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for implementing a plurality of buckets to evaluate one or more profiles and/or optimize one or more features are provided. In some examples, a content system may provide content items (e.g., advertisements, images, links, videos, etc.) to be presented via various internet resources (e.g., web pages, applications, etc.). The content system may send content item requests to content item servers (e.g., supply-side servers and/or content exchanges). A content item request may be associated with a timeout value corresponding to a duration of a window of time associated with a response to the content item request (e.g., the content system may expect to receive the response to the content item request within the window of time). However, there may not be a fixed timeout setting that works uniformly well for all domains at all times. For example, a timeout value may not work well for content item requests in a first situation, but the same timeout value may work well for content item requests in a second situation (e.g., due to at least one of a change time of day, a change in conditions, such as traffic levels, of content item servers, etc. between the first situation and the second situation). Accordingly, it may be beneficial to update the timeout value over time to reflect changing conditions.

Thus, in accordance with one or more of the techniques herein, a bucketing system is provided that performs an optimization process to (automatically and/or without manual intervention, for example) evaluate performance levels of various timeout values and/or determine a best performing timeout value among the various timeout values. In an example, a plurality of buckets may be configured for the optimization process. Each of the plurality of buckets may be associated with a timeout value. In an example, the plurality of buckets may comprise five buckets associated with a 1 second timeout, a 1.25 second timeout, a 1.5 second timeout, a 1.75 second timeout and a 2 second timeout, respectively. In some examples, the optimization process may be associated with a first target proportion of content item requests to be assigned to a production bucket of the plurality of buckets, and/or a second target proportion of content item requests to be distributed among experiment buckets of the plurality of buckets. In an example, the first target proportion of content item requests for the production bucket may be 90% (or other value) and the second target proportion of content item requests to be distributed among the experiment buckets may be 10%. In some examples, the experiment buckets comprise some or all of the plurality of buckets. A quantity of the plurality of buckets, timeout values associated with the plurality of buckets, the first target proportion, the second target proportion, and/or other characteristics associated with the optimization process and/or the plurality of buckets may be configured using a bucket configuration, which may be based upon user-input information received via a user interface.

In an example in which the first target proportion of content item requests for the production bucket is 90% and the second target proportion of content item requests to be distributed among the experiment buckets is 10%, in a first optimization cycle associated with a first evaluation period (e.g., an initial evaluation period) of the optimization process, the bucketing system may (i) assign a set of content item requests amounting to about 90% of content item requests of the first evaluation period to a bucket of the plurality of buckets that is designated the production bucket for the first evaluation period, and/or (ii) distribute content item requests amounting to about 10% of the content item requests of the first evaluation period among experiment buckets of the plurality of buckets. In some examples, a timeout value associated with a bucket may be used for content item requests that are assigned to the bucket. For example, the content item requests (transmitted by the content system to one or more content item servers, for example) may be indicative of the timeout value associated with the bucket to which the content item requests are assigned.

In some examples, evaluation metrics associated with the plurality of buckets may be determined based upon responses received in response to the content item requests transmitted in the first evaluation period. In some examples, the evaluation metrics may comprise at least one of a response latency metric, a measure of responses, and/or other metrics associated with the content item requests transmitted in the first evaluation period. The evaluation metrics may be used to select a winning bucket as the production bucket for a second evaluation period following (e.g., directly following) the first evaluation period. In an example, bucket scores associated with the plurality of buckets may be determined based upon the evaluation metrics, and/or the winning bucket may be selected based upon a determination that a bucket score of the winning bucket is the highest bucket score among the bucket scores. Accordingly, if the winning bucket is different than the bucket designated the production bucket for the first evaluation period, the production bucket may switch buckets from the first evaluation period to the second evaluation period. The bucketing system may (automatically) perform evaluations of the optimization process (in which the bucketing system analyzes evaluation metrics and/or bucket scores to select a winning bucket as the production bucket) periodically according to an evaluation frequency, which may be configured based upon the bucket configuration. Accordingly, by performing the optimization process, the production bucket may be (automatically and/or without manual intervention) periodically updated (e.g., switched between buckets of the plurality of buckets) based upon information (e.g., results of content item requests performed using various timeout values) reflective of real-time conditions, thereby providing for improved performance of the content system.

It may be appreciated that the techniques provided herein are not limited to content item requests, but may be used in other applications (e.g., other web traffic applications, electrical applications, electromechanical applications, mechanical applications, etc.), for example, applications in which a plurality of buckets are used to test various profiles (e.g., various configurations and/or values) to identify a best performing configuration and/or update a production bucket based upon the best performing configuration.

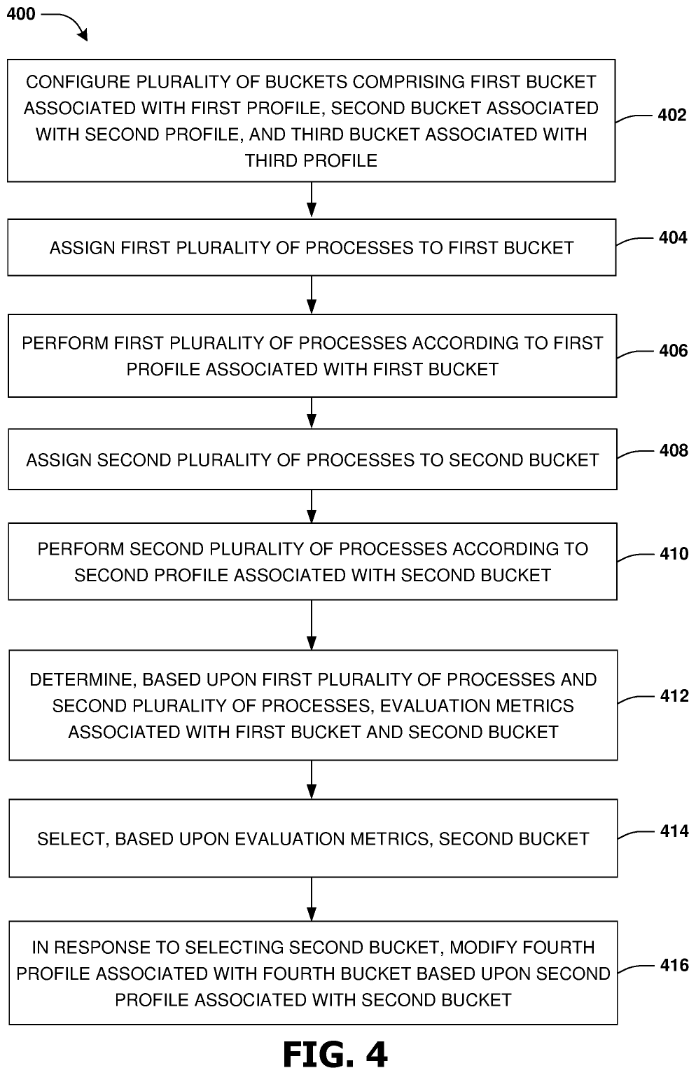

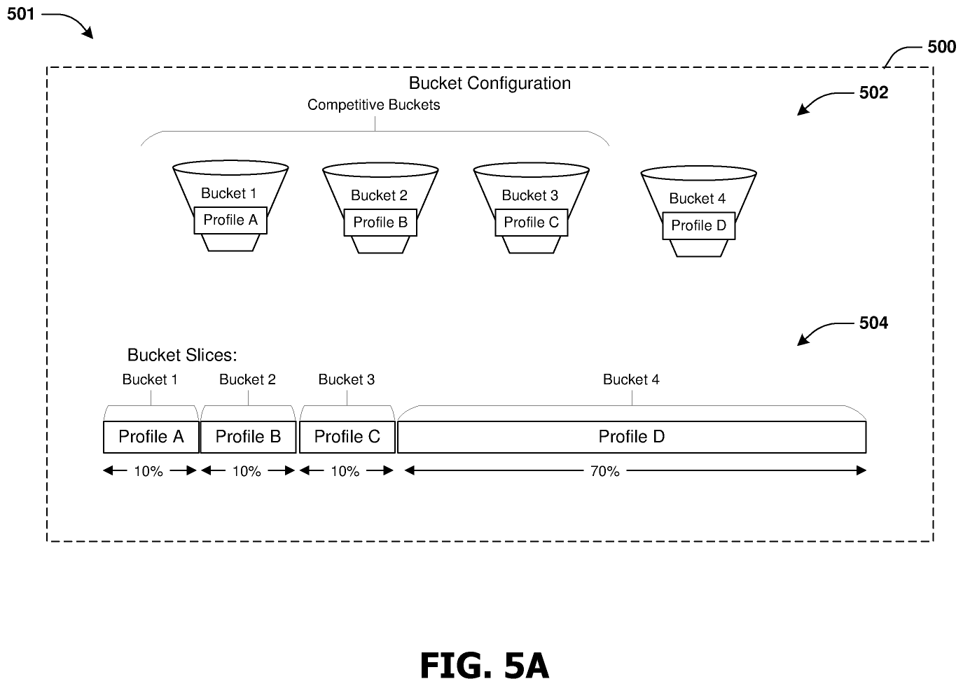

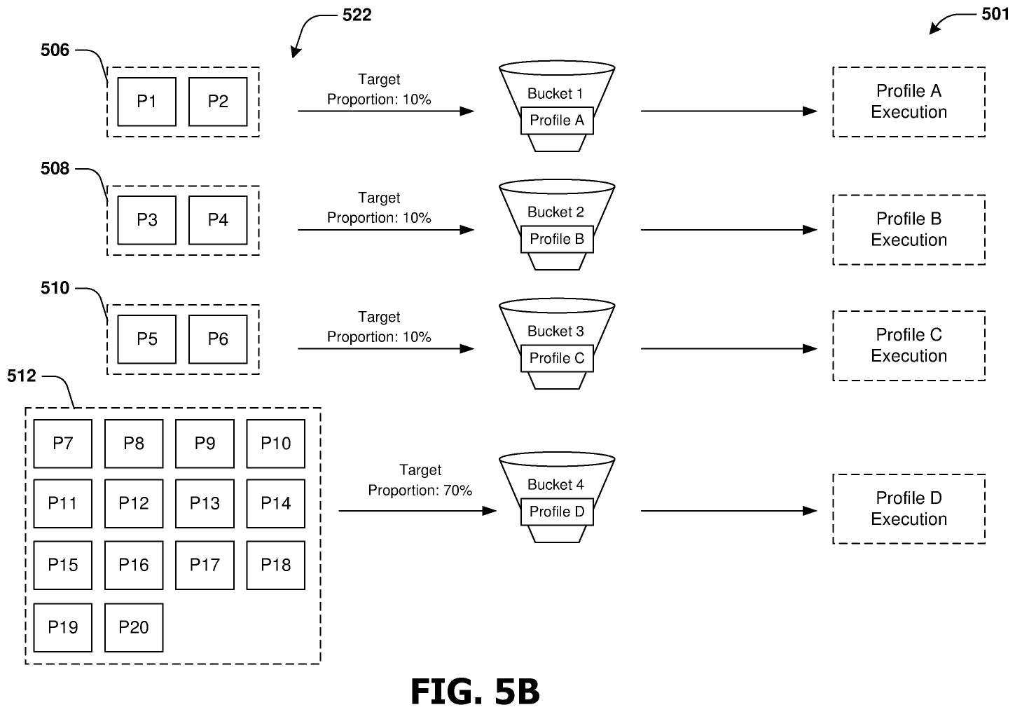

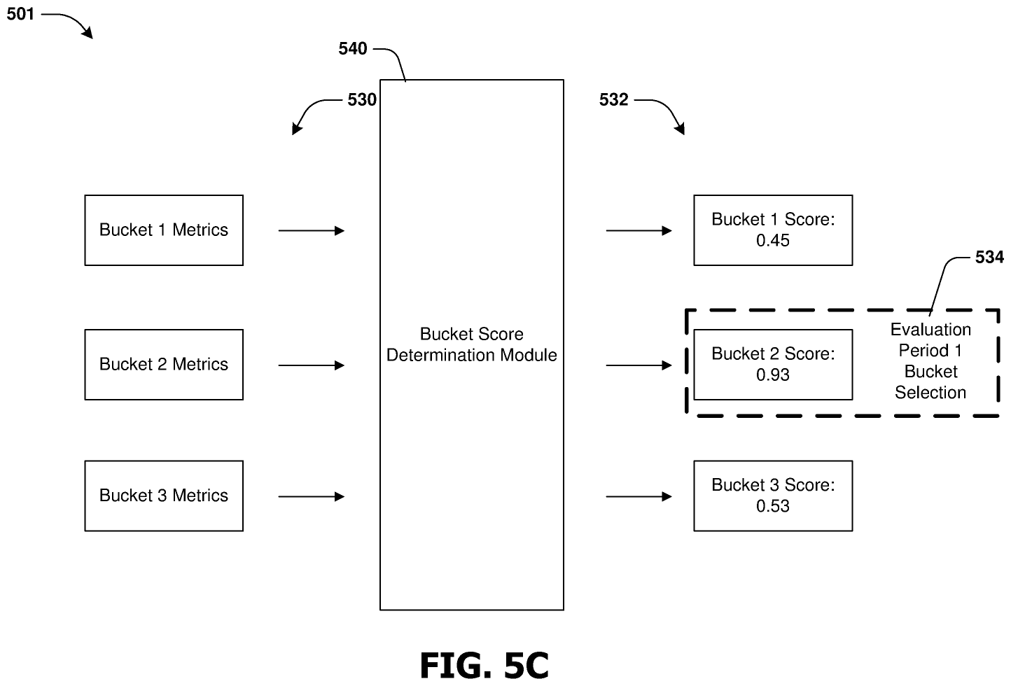

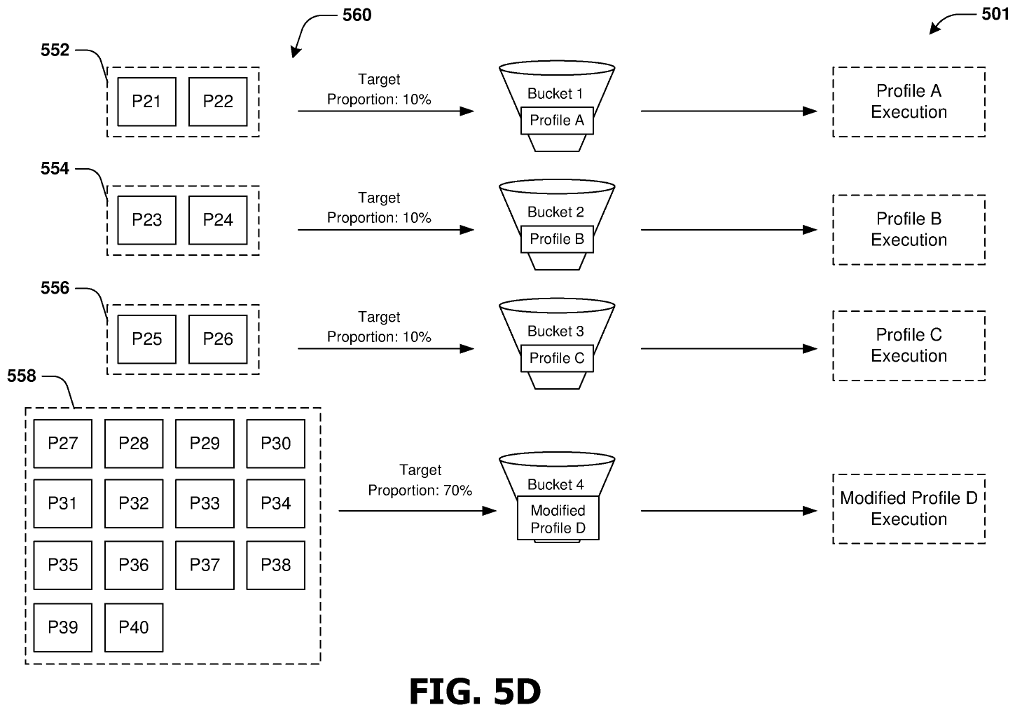

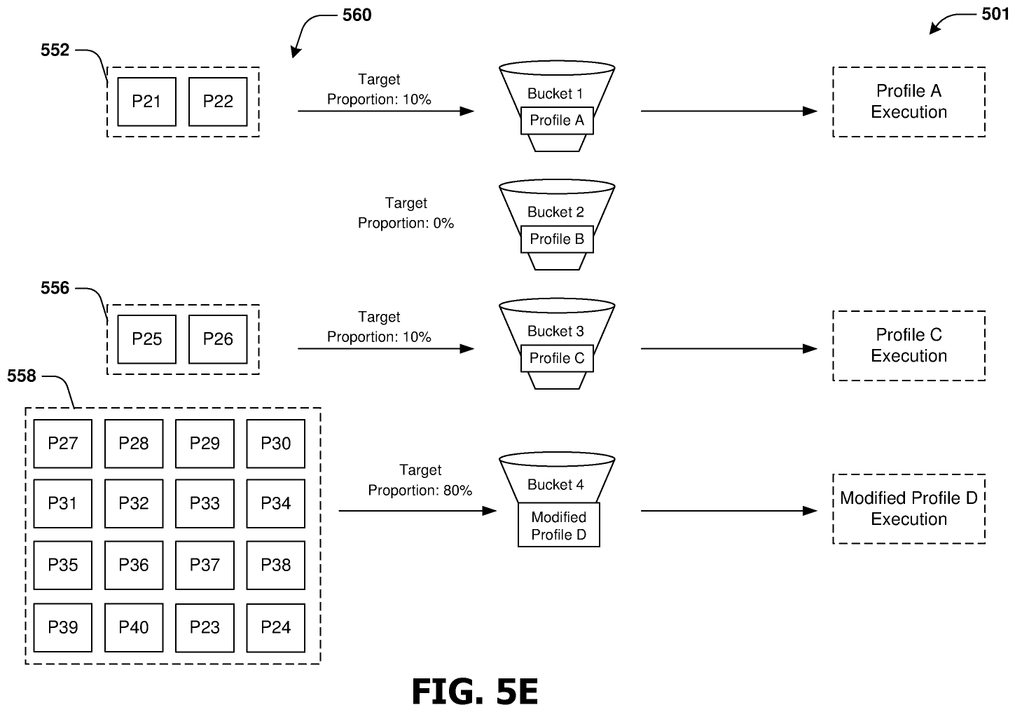

An embodiment of implementing a plurality of buckets to evaluate one or more profiles and/or optimize one or more features is illustrated by an example method 400 of FIG. 4, which is described in conjunction with an example system 501 of FIGS. 5A-5E. At 402, a bucketing system may configure a first plurality of buckets. For example, the first plurality of buckets may be configured based upon a first bucket configuration. In some examples, the first bucket configuration may correspond to a feature bucket configuration associated with a feature (e.g., the feature bucket configuration may configure buckets associated with the feature).

FIG. 5A illustrates an example of the first bucket configuration (shown with reference number 500). The first bucket configuration 500 may be indicative of the first plurality of buckets (shown with reference number 502) comprising a first bucket “Bucket 1”, a second bucket “Bucket 2”, a third bucket “Bucket 3” and/or a fourth bucket “Bucket 4”. In some examples, Bucket 4 may correspond to a production bucket (which may also be referred to as a “performing bucket” and/or a “prod bucket”) whose profile and/or configuration may be controlled based upon performance of processes of a set of competitive buckets comprising buckets (of the first plurality of buckets 502) other than Bucket 4 (e.g., the production bucket). The set of competitive buckets may comprise Bucket 1, Bucket 2 and/or Bucket 3. Although FIG. 5A shows four buckets of the first plurality of buckets 502 (and/or three buckets of the set of competitive buckets), other quantities of buckets of the first plurality of buckets 502 (and/or the set of competitive buckets) are within the scope of the present disclosure.

In some examples, each bucket of one, some and/or all of the first plurality of buckets 502 may be configured with a target proportion (e.g., a bucket slice). For example, a bucket slice representation 504 shows a first target proportion of 10% for Bucket 1, a second target proportion of 10% for Bucket 2, a third target proportion of 10% for Bucket 3, and/or a fourth target proportion of 70% for Bucket 4 (e.g., the production bucket). According to the example shown in FIG. 5A, based upon the first bucket configuration 500, the bucketing system may attempt to assign 10% of processes (e.g., processes in an evaluation period) to Bucket 1, 10% of the processes to Bucket 2, 10% of the processes to Bucket 3 and/or 70% of the processes to Bucket 4.

In some examples, the first bucket configuration 500 may comprise a configuration of a plurality of profiles associated with the first plurality of buckets 502. For example, each bucket of one, some and/or all of the first plurality of buckets 502 may be configured with a profile of the plurality of profiles. For example, Bucket 1 may be configured with a first profile “Profile A”, Bucket 2 may be configured with a second profile “Profile B”, Bucket 3 may be configured with a third profile “Profile C”, and/or Bucket 4 may be configured with a fourth profile “Profile D”.

In some examples, the plurality of profiles (e.g., Profile A, Profile B, Profile C and/or Profile D) may be associated with one or more first features. In some examples, the one or more first features may be associated with one or more processes. In an example, (i) Profile A may comprise at least one of a first configuration, one or more first values, etc. for the one or more first features, (ii) Profile B may comprise at least one of a second configuration, one or more second values, etc. for the one or more first features and/or (iii) Profile C may comprise at least one of a third configuration, one or more third values, etc. for the one or more first features.

In an example, the one or more first features may correspond to one or more video streaming parameters of a video streaming process. The one or more video streaming parameters may comprise a video resolution and/or a bit rate of the video streaming process. Profile A may comprise a first video resolution and/or a first bit rate, Profile B may comprise a second video resolution and/or a second bit rate, and/or Profile C may comprise a third video resolution and/or a third bit rate.

In some examples, the first bucket configuration 500 (and/or the first plurality of buckets 502) may be configured for use in evaluating configurations of a first application (e.g., the configurations may be associated with Profiles A-C of the set of competitive buckets, for example). The first application may correspond to at least one of a mobile application, a web application, a backend application, etc. In an example, the one or more first features may correspond to one or more features (e.g., one or more settings, one or more parameters, etc.) of the first application. Evaluation metrics associated with the set of competitive buckets may be determined and/or used to select a bucket (e.g., a winning bucket and/or best performing bucket) among the set of competitive buckets. A profile of the production bucket (e.g., Profile D of Bucket 4) may be modified based upon the selected bucket.

In some examples, at least some of the first bucket configuration 500 may be based upon user-input information (e.g., user-input settings). The user-input information may be received via one or more user interactions with a user interface provided by the bucketing system, for example. In an example, the user-input information may indicate at least one of (i) a value for a quantity of competitive buckets (e.g., 3 in FIG. 3B), (ii) a target proportion of processes for all competitive buckets (e.g., the target proportion of 10% for each bucket of Buckets 1-3 may be derived from an indication, in the user-input information, of a 30% target proportion for all competitive buckets), (iii) a default value and/or configuration of the production bucket (e.g., an initial state of Profile D before Profile D is modified), etc. In an example, the user-input information may be received via one or more user interactions with one or more text fields and/or selectable inputs (e.g., buttons) in the user interface provided by the bucketing system.

FIG. 5B illustrates the bucketing system assigning processes 522 to various buckets (according to the first bucket configuration 500, for example). The processes 522 may be performed in a first evaluation period. For example, results of at least some of the processes 522 may be used to determine evaluation metrics (reflective of performance of the various buckets during the first evaluation period, for example), which may be used to select a bucket (e.g., a winning bucket and/or best performing bucket) among the set of competitive buckets.

At 404 of FIG. 4, the bucketing system may assign a first plurality of processes 506 (e.g., processes “P1” and “P2” shown in FIG. 5B) to Bucket 1. In some examples, the bucketing system assigns the first plurality of processes 506 to Bucket 1 based upon the first target proportion (such that the first plurality of processes 506 assigned to Bucket 1 make up about 10% of the processes 522 in the first evaluation period, for example). At 406 of FIG. 4, the bucketing system may perform the first plurality of processes 506 (assigned to Bucket 1) according to Profile A associated with Bucket 1 (via performing “Profile A Execution” shown in FIG. 5B, for example).

At 408 of FIG. 4, the bucketing system may assign a second plurality of processes 508 (e.g., processes “P3” and “P4” shown in FIG. 5B) to Bucket 2. In some examples, the bucketing system assigns the second plurality of processes 508 to Bucket 2 based upon the second target proportion (such that the second plurality of processes 508 assigned to Bucket 2 make up about 10% of the processes 522 in the first evaluation period, for example). At 410 of FIG. 4, the bucketing system may perform the second plurality of processes 508 (assigned to Bucket 2) according to Profile B associated with Bucket 2 (via performing “Profile B Execution” shown in FIG. 5B, for example).

In some examples, the bucketing system may assign a third plurality of processes 510 (e.g., processes “P5” and “P6” shown in FIG. 5B) to Bucket 3. In some examples, the bucketing system assigns the third plurality of processes 510 to Bucket 3 based upon the third target proportion (such that the third plurality of processes 510 assigned to Bucket 3 make up about 10% of the processes 522 in the first evaluation period, for example). In some examples, the bucketing system may perform the third plurality of processes 510 (assigned to Bucket 3) according to Profile C associated with Bucket 3 (via performing “Profile C Execution” shown in FIG. 5B, for example).

In some examples, the bucketing system may assign a fourth plurality of processes 512 (e.g., processes P7-P20″ shown in FIG. 5B) to Bucket 4. In some examples, the bucketing system assigns the fourth plurality of processes 512 to Bucket 4 based upon the fourth target proportion (such that the fourth plurality of processes 512 assigned to Bucket 4 make up about 70% of the processes 522 in the first evaluation period, for example). In some examples, the bucketing system may perform the fourth plurality of processes 512 (assigned to Bucket 4) according to Profile D associated with Bucket 4 (via performing “Profile D Execution” shown in FIG. 5B, for example).

At 412 of FIG. 4, the bucketing system may determine first evaluation metrics based upon at least some of the processes 522 (associated with the first evaluation period, for example). In an example, the first evaluation metrics may be associated with at least some of the first plurality of buckets 502 (e.g., the first evaluation metrics may be associated with the set of competitive buckets of the first plurality of buckets 502), and/or the first evaluation metrics may be determined based upon processes (e.g., the first plurality of processes 506, the second plurality of processes 508 and/or the third plurality of processes 510) assigned to the first plurality of buckets 502. For example, the first evaluation metrics may be determined based upon results of the processes assigned to the first plurality of buckets 502.

In some examples, the first evaluation metrics may be used to determine first bucket scores associated with at least some of the first plurality of buckets 502. For example, the first bucket scores may be associated with the set of competitive buckets (e.g., buckets 1-3). Embodiments are contemplated in which the first bucket scores comprise a bucket score associated with Bucket 4 (e.g., the production bucket). FIG. 5C illustrates the bucketing system determining the first bucket scores (shown with reference number 532) based upon the first evaluation metrics (shown with reference number 530). In the example shown in FIG. 50, the first evaluation metrics 530 may comprise a first set of one or more evaluation metrics “Bucket 1 Metrics” associated with Bucket 1, a second set of one or more evaluation metrics “Bucket 2 Metrics” associated with Bucket 2 and/or a third set of one or more evaluation metrics “Bucket 3 Metrics” associated with Bucket 3. In an example, the Bucket 1 Metrics may be based upon results of the first plurality of processes 506 performed according to Profile A associated with Bucket 1, the Bucket 2 Metrics may be based upon results of the second plurality of processes 508 performed according to Profile B associated with Bucket 2 and/or the Bucket 3 Metrics may be based upon results of the third plurality of processes 510 performed according to Profile C associated with Bucket 3.

In the example shown in FIG. 5C, the first bucket scores 532 may be determined using a bucket score determination module 540 (which may receive the first evaluation metrics 530 as input, for example). The first bucket scores 532 may comprise (i) a first bucket score “Bucket 1 Score” (e.g., 0.45) determined based upon the Bucket 1 Metrics associated with Bucket 1, (ii) a second bucket score “Bucket 2 Score” (e.g., 0.93) determined based upon the Bucket 2 Metrics associated with Bucket 2 and/or (iii) a third bucket score “Bucket 3 Score” (e.g., 0.53) determined based upon the Bucket 3 Metrics associated with Bucket 3.

It may be appreciated that by determining the first evaluation metrics 530 based upon processes assigned to the set of competitive buckets, and/or by determining the first bucket scores 532 based upon the first evaluation metrics 530, the first bucket scores 532 may be reflective of performance levels associated with the set of competitive buckets. For example, the Bucket 1 Metrics and/or the Bucket 1 Score may be reflective of a first performance level associated with Bucket 1 and/or Profile A (e.g., the first performance level may correspond to a quality of performance of the first plurality of processes 506 performed according to Profile A). In an example in which Profile A is indicative of at least one of the first configuration, the one or more first values, etc. of the one or more first features of the first application, the first performance level may correspond to a quality of performance of the first application when the one or more first features of the first application are implemented according to at least one of the first configuration, the one or more first values, etc. Alternatively and/or additionally, the Bucket 2 Metrics and/or the Bucket 2 Score may be reflective of a second performance level associated with Bucket 2 and/or Profile B (e.g., the second performance level may correspond to a quality of performance of the second plurality of processes 508 performed according to Profile B). In an example in which Profile B is indicative of at least one of the second configuration, the one or more second values, etc. of the one or more first features of the first application, the second performance level may correspond to a quality of performance of the first application when the one or more first features of the first application are implemented according to at least one of the second configuration, the one or more second values, etc. Alternatively and/or additionally, the Bucket 3 Metrics and/or the Bucket 3 Score may be reflective of a third performance level associated with Bucket 3 and/or Profile C (e.g., the third performance level may correspond to a quality of performance of the third plurality of processes 510 performed according to Profile C). In an example in which Profile C is indicative of at least one of the third configuration, the one or more third values, etc. of the one or more first features of the first application, the third performance level may correspond to a quality of performance of the first application when the one or more first features of the first application are implemented according to at least one of the third configuration, the one or more third values, etc.

At 414 of FIG. 4, the bucketing system may select Bucket 2 based upon the first evaluation metrics 530. For example, the bucketing system may select Bucket 2 based upon the first bucket scores 532 determined based upon the first evaluation metrics 530. In an example, the bucketing system may select Bucket 2 from the first plurality of buckets 502 (e.g., the bucketing system may select Bucket 2 from the set of competitive buckets of the first plurality of buckets 502). In some examples, the bucketing system may select 534 Bucket 2 based upon a determination that the Bucket 2 Score is higher than a threshold. In the example shown in FIG. 5C, the bucketing system may select 534 Bucket 2 based upon a determination that the Bucket 2 Score is the highest bucket score among the first bucket scores 532 (e.g., the Bucket 2 Score is 0.93, which is higher than the Bucket 1 Score of 0.45 and the Bucket 3 Score of 0.53). For example, the determination that the Bucket 2 Score is the highest bucket score among the first bucket scores 532 may correspond to a determination that Bucket 2 is the best performing bucket among the set of competitive buckets during the first evaluation period. For example, during the first evaluation period, the second plurality of processes 508 performed according to Profile B (associated with Bucket 2) may outperform other processes performed according to other profiles (e.g., Profile A, Profile C and Profile D).

At 416, in response to selecting Bucket 2, the bucketing system may modify Profile D associated with Bucket 4 (e.g., the production bucket) based upon Profile B associated with Bucket 2. For example, the bucketing system may generate a modified version of Profile D based upon Profile B. In some examples, prior to modifying Profile D, Profile D comprises at least one of a fourth configuration, one or more fourth values, etc. In some examples, the fourth configuration may be the same as or different than the first configuration of Profile A, the second configuration of Profile B, and/or the third configuration of Profile C. In some examples, the one or more fourth values may be the same as or different than the one or more first values of Profile A, the one or more second values of Profile B, and/or the one or more third values of Profile C. In some examples, the fourth configuration may correspond to the default value and/or configuration indicated by the user-input information. In some examples, at least one of the fourth configuration, the one or more fourth values, etc. may be associated with the one or more first features of the first application. In some examples, modifying Profile D comprises modifying, based upon Profile B, at least one of the fourth configuration, the one or more fourth values, etc. of Profile D to at least one of an updated configuration, one or more updated values, etc. to be included in the modified version of Profile D. In some examples, the modified version of Profile D may match Profile B. For example, at least one of the updated configuration, the one or more updated values, etc. may be identical (e.g., equal) to at least one of the second configuration, the one or more second values, etc. of Profile B.

In some examples, after modifying Profile D based upon Profile B, processes assigned to Bucket 4 may be performed according to the modified version of Profile D.

FIG. 5D illustrates the bucketing system assigning second processes 560 to various buckets (according to the first bucket configuration 500, for example). The second processes 560 may be performed in a second evaluation period after the first evaluation period. For example, results of at least some of the second processes 560 may be used to determine evaluation metrics (reflective of performance of the various buckets during the second evaluation period, for example), which may be used to select a bucket (e.g., a winning bucket and/or best performing bucket) among the set of competitive buckets.

In some examples, the bucketing system may assign a fifth plurality of processes 552 (e.g., processes “P21” and “P22” shown in FIG. 5D) to Bucket 1. In some examples, the bucketing system assigns the fifth plurality of processes 552 to Bucket 1 based upon the first target proportion (such that the fifth plurality of processes 552 assigned to Bucket 1 make up about 10% of the second processes 560 in the second evaluation period, for example). The bucketing system may perform the fifth plurality of processes 552 (assigned to Bucket 1) according to Profile A associated with Bucket 1 (via performing “Profile A Execution” shown in FIG. 5D, for example).

In some examples, the bucketing system may assign a sixth plurality of processes 554 (e.g., processes “P23” and “P24” shown in FIG. 5D) to Bucket 2. In some examples, the bucketing system assigns the sixth plurality of processes 554 to Bucket 2 based upon the second target proportion (such that the sixth plurality of processes 554 assigned to Bucket 2 make up about 10% of the second processes 560 in the second evaluation period, for example). The bucketing system may perform the sixth plurality of processes 554 (assigned to Bucket 2) according to Profile B associated with Bucket 2 (via performing “Profile B Execution” shown in FIG. 5D, for example).

In some examples, the bucketing system may assign a seventh plurality of processes 556 (e.g., processes “P25” and “P26” shown in FIG. 5D) to Bucket 3. In some examples, the bucketing system assigns the seventh plurality of processes 556 to Bucket 3 based upon the third target proportion (such that the seventh plurality of processes 556 assigned to Bucket 3 make up about 10% of the second processes 560 in the second evaluation period, for example). The bucketing system may perform the seventh plurality of processes 556 (assigned to Bucket 3) according to Profile C associated with Bucket 3 (via performing “Profile C Execution” shown in FIG. 5D, for example).

In some examples, the bucketing system may assign an eighth plurality of processes 558 (e.g., processes P27-P40″ shown in FIG. 5D) to Bucket 4. In some examples, the bucketing system assigns the eighth plurality of processes 558 to Bucket 4 based upon the fourth target proportion (such that the eighth plurality of processes 558 assigned to Bucket 4 make up about 70% of the second processes 560 in the second evaluation period, for example). In some examples, the bucketing system may perform the eighth plurality of processes 558 (assigned to Bucket 4) according to the modified version of Profile D associated with Bucket 4 (via performing “Modified Profile D Execution” shown in FIG. 5D, for example). For example, the eighth plurality of processes 558 may be performed using at least one of the updated configuration, the one or more updated values, etc. of the modified version of Profile D (which may be identical to at least one of the second configuration, the one or more second values, etc. of Profile B, for example).

In some examples, the modified version of Profile D may match Profile B. For example, at least one of the updated configuration, the one or more updated values, etc. may be identical (e.g., equal) to at least one of the second configuration, the one or more second values, etc. of Profile B. Accordingly, in the second evaluation period, processes assigned to Bucket 2 may be performed in the same (and/or similar) manner as processes assigned to Bucket 4. In some examples, when a version of Profile D that is being used to perform processes assigned to Bucket 4 (e.g., the production bucket) matches a profile of a bucket of the set of competitive buckets, the bucket (of the set of competitive buckets) is deactivated. For example, since the modified version of Profile D that is being used to perform processes assigned to Bucket 4 during the second evaluation period matches Profile B of Bucket 2, Bucket 2 may be deactivated during the second evaluation period. FIG. 5E illustrates an example in which Bucket 2 is deactivated during the second evaluation period. In some examples, target proportions of remaining buckets may be adjusted (to have a sum of 100%, for example). In the example shown in FIG. 5E, the first target proportion (associated with Bucket 1) is 10%, the second target proportion (associated with Bucket 2) is 0% (e.g., Bucket 2 is deactivated), the third target proportion (associated with Bucket 3) is 10%, and/or the fourth target proportion (associated with Bucket 4) is 80%.

In some examples, the bucketing system may determine second evaluation metrics based upon at least some of the second processes 560 (associated with the second evaluation period, for example). In an example, the second evaluation metrics may be associated with the first plurality of buckets 502, and/or the second evaluation metrics may be determined based upon (results of) at least some of the second processes 560 assigned to at least some of the first plurality of buckets 502 (e.g., buckets that are activated during the second evaluation period).

In some examples, the second evaluation metrics may be used to determine second bucket scores associated with at least some of the first plurality of buckets 502 (e.g., buckets that are activated during the second evaluation period). For example, a score the second bucket scores may be indicative of a performance level of a corresponding bucket (and/or processes assigned to the corresponding bucket) of the first plurality of buckets 502 during the second evaluation period.

In some examples, the bucketing system may select a bucket based upon the second evaluation metrics. For example, the bucketing system may select the selected bucket based upon the second bucket scores determined based upon the second evaluation metrics. In an example, the bucketing system may select the selected bucket from at least some of the first plurality of buckets 502 (e.g., the bucketing system may select the selected bucket from buckets that are activated during the second evaluation period). In some examples, the bucketing system may select the selected bucket based upon a determination that a bucket score associated with the selected bucket is higher than a threshold. In some examples, the bucketing system may select the selected bucket based upon a determination that the bucket score is the highest bucket score among the second bucket scores. For example, the determination that the bucket score is the highest bucket score among the second bucket scores may correspond to a determination that the selected bucket is the best performing bucket among the first plurality of buckets 502 during the second evaluation period.

In some examples, if the selected bucket is Bucket 4 (e.g., the production bucket), the bucketing system may not modify Profile D associated with Bucket 4 (e.g., may not further modify the modified version of Profile D) in response to the selection. In some examples, if the selected bucket is another bucket (e.g., Bucket 1, Bucket 3) other than Bucket 4 and has a profile that does not match the modified version of Profile D, the bucketing system may modify Profile D to a second modified version.

In an example in which the selected bucket is Bucket 3, in response to selecting Bucket 3, the bucketing system may modify Profile D associated with Bucket 4 (e.g., the production bucket) based upon Profile C associated with Bucket 3. For example, the bucketing system may generate the second modified version of Profile D based upon Profile C. In some examples, modifying Profile D comprises modifying, based upon Profile C, at least one of the configuration, the one or more values, etc. of the modified version of Profile D used in the first evaluation period to at least one of a second updated configuration, one or more second updated values, etc. to be included in the second modified version of Profile D. In some examples, the second modified version of Profile D may match Profile C. For example, at least one of the second updated configuration, the one or more second updated values, etc. may be identical (e.g., equal) to at least one of the third configuration, the one or more third values, etc. of Profile C.

In some examples, after modifying Profile D based upon Profile C to generate the second modified version of Profile D, processes assigned to Bucket 4 may be performed according to the second modified version of Profile D.

In some examples, one or more of the techniques provided herein are used to perform a first optimization process (on the one or more first features of the first application, for example). In some examples, the first optimization may run for at least part of a lifetime of the first application. The bucketing system may perform (e.g., continuously perform) the first optimization process during (and/or in conjunction with) execution of processes of the first application, so as to automatically optimize the first application (e.g., while the first application is running, the bucketing system may automatically determine the best performing value and/or configuration for the one or more first features of the first application, and/or may implement the one or more first features based upon the best performing value and/or configuration).

In some examples, the first optimization process comprises optimization cycles. Each optimization cycle may be associated with evaluation periods. For example, the first optimization process may comprise a first optimization cycle associated with the first evaluation period (discussed with respect to FIGS. 5B-5C), a second optimization cycle associated with the second evaluation period (discussed with respect to FIGS. 5D-5E), a third optimization cycle associated with a third evaluation period after the second evaluation period, etc. In some examples, optimization cycles of the first optimization process may be performed continuously such that when one optimization cycle ends another optimization cycle begins. In some examples, there may be breaks and/or pauses between evaluation periods and/or optimization cycles of the first optimization process.

In an example, an optimization cycle (e.g., the first optimization cycle, the second optimization cycle, etc.) of the first optimization process incudes (i) assigning processes of an evaluation period to buckets of the first plurality of buckets 502 (e.g., assigning the processes 522 to the first plurality of buckets 502 in the first evaluation period as shown in FIG. 5B), (ii) performing the processes according to profiles associated with buckets to which the processes were assigned (e.g., Profile A Execution, Profile B Execution, Profile C Execution, and/or Profile D Execution shown in FIG. 5B), (iii) determining evaluation metrics associated with the processes performed during the evaluation period (e.g., determining the first evaluation metrics 530 shown in FIG. 5C), (iv) determining bucket scores associated with buckets of the first plurality of buckets 502 based upon the evaluation metrics (e.g., determining the first bucket scores 532), (v) selecting a bucket from among the first plurality of buckets 502 based upon the bucket scores (e.g., selecting 534 Bucket 2 in FIG. 5C based upon the first bucket scores 532), and/or (vi) performing a bucket reconfiguration process for a subsequent optimization cycle associated with a subsequent evaluation period. The subsequent evaluation period may follow the evaluation period of the optimization cycle (e.g., the subsequent evaluation period may be a next evaluation period directly following the evaluation period).

In some examples, the bucket reconfiguration process comprises determining whether to perform one or more bucket reconfiguration acts for the subsequent optimization cycle. In some examples, the bucketing system may determine not to perform the one or more bucket reconfiguration acts based upon (i) the selected bucket being Bucket 4 (e.g., the production bucket), which may reflect that Profile D associated with Bucket 4 does not need to be changed since Bucket 4 was selected as a winning bucket (e.g., best performing bucket) among the first plurality of buckets 502, and/or (ii) the selected bucket being associated with a profile that matches (e.g., is identical to) the version of Profile D that was used in the evaluation period to perform processes assigned to Bucket 4.

In some examples, the bucketing system may determine to perform the one or more bucket reconfiguration acts based upon (i) the selected bucket being different than Bucket 4 (e.g., the production bucket), and/or (ii) the selected bucket being associated with a profile that does not match (e.g., is not identical to and/or has one or more differences with) the version of Profile D that was used in the evaluation period to perform processes assigned to Bucket 4.

In some examples, in response to determining not to perform the one or more bucket reconfiguration acts, the bucketing system may not modify a bucket and/or profile configuration associated with the first plurality of buckets 502 used in the evaluation period of the optimization cycle. In some examples, in response to determining not to perform the one or more bucket reconfiguration acts, the bucketing system may use the same bucket and/or profile configuration (that was used in the evaluation period) for the subsequent evaluation period of the subsequent optimization cycle.

In some examples, the one or more bucket reconfiguration acts may comprise (i) activating and/or deactivating one or more buckets (e.g., Bucket 2 is deactivated in FIG. 5E since Profile B associated with Bucket 2 matches the modified version of Profile D associated with Bucket 4), (ii) reconfiguring one or more target proportions of one or more buckets, and/or (iii) modifying one or more profiles (e.g., Profile A, Profile B, Profile C and/or Profile D) associated with one or more buckets of the first plurality of buckets 502. In some examples, after performing the one or more bucket reconfiguration acts to produce re-configured buckets and/or profiles, the bucketing system may use the re-configured buckets and/or profiles in the subsequent evaluation period of the subsequent optimization cycle, which the bucketing system may perform using one or more of the techniques provided herein with respect to performing the optimization cycle.

In some examples, the bucketing system may perform optimization cycles based upon a first duration of time. The first duration of time may correspond to a duration of an evaluation period (e.g., the first evaluation period, the second evaluation period, etc.) of an optimization cycle (e.g., each optimization cycle) of the first optimization process. In some examples, the first duration of time may be indicated by the user-input information. In an example in which the first duration of time is five minutes, evaluation periods of the optimization cycles of the first optimization process may correspond to five minute windows of time. Accordingly, bucket reconfiguration processes (in which the bucketing system determines whether to perform one or more bucket reconfiguration acts and/or performs the one or more bucket reconfiguration acts) may be performed for the first plurality of buckets 502 periodically according to the first duration of time, such as about five minutes apart when the first duration of time is five minutes.

Alternatively and/or additionally, the bucketing system may perform one or more of the techniques provided herein with respect to the one or more first features for other features (of the first application, for example) in addition to the one or more first features. For example, the bucketing system may configure a second plurality of buckets for one or more second features (of the first application) different than the one or more first features. The bucketing system may use the second plurality of buckets to perform a second optimization process on the one or more second features. The second optimization process may comprise determining (while the first application is running, for example) the best performing value and/or configuration for the one or more second features (e.g., determining a best performing bucket among the second plurality of buckets), and/or implementing the one or more second features according to the best performing value and/or configuration. The second optimization process may be performed using one or more of the techniques provided herein with respect to the first optimization process.

The first optimization process, the second optimization process and/or other optimization processes (associated with optimizing the first application, for example) may be performed concurrently. In some examples, each of the optimization processes is associated with optimizing a set of features (e.g., a unique set of one or more features) of the first application. In an example, each of the optimization processes may be performed during (and/or in conjunction with) execution of processes of the first application, and may automatically optimize a set of one or more features of the first application.

In an example in which the one or more first features correspond to one or more video streaming parameters, the first evaluation metrics 530 may comprise at least one of a buffering time, a lag length, a play length, a lag ratio, etc. associated with one or more video streaming processes performed according to a profile of a bucket of the first plurality of buckets 502. A video stream performed according to Profile A, for example, may comprise presenting a video on a client device based upon the first video resolution and/or the first bit rate indicated by Profile A. In some examples, selecting 534 Bucket 2 in FIG. 5C based upon the Bucket 2 Score being the highest score among the first bucket scores 532 may indicate that using the second video resolution and/or the second bit rate (according to Profile B) in video streaming processes during the first evaluation period provides for the highest performance level among video resolutions and/or bit rates tested using the first plurality of buckets 502. For example, video streaming sessions performed according to the second video resolution and/or the second bit rate may have at least one of reduced lag, reduced buffering time, smoother playback, etc. compared to using other video resolutions and/or other bit rates. In some examples, in response to selecting 534 Bucket 2, Profile D may be modified by (i) modifying a fourth video resolution indicated by Profile D to a modified video resolution based upon the second video resolution indicated by Profile B, and/or (ii) modifying a fourth bit rate indicated by Profile D to a modified bit rate based upon the second bit rate indicated by Profile B. In response to modifying Profile D to the modified version of Profile D comprising the modified video resolution and/or the modified bit rate, the modified video resolution and/or the modified bit rate may be used for video streaming processes assigned to Bucket 4. For example, the eighth plurality of processes 558 (in FIGS. 5D and 5E) assigned to Bucket 4 in the second evaluation period may comprise presenting videos on client devices based upon the modified video resolution and/or the modified bit rate (e.g., the videos may be presented to have the modified video resolution and/or the modified bit rate). In some examples, the modified video resolution and/or the modified bit rate (used for video streaming processes assigned to Bucket 2) may be equal to the second video resolution and/or the second bit rate indicated by Profile B.

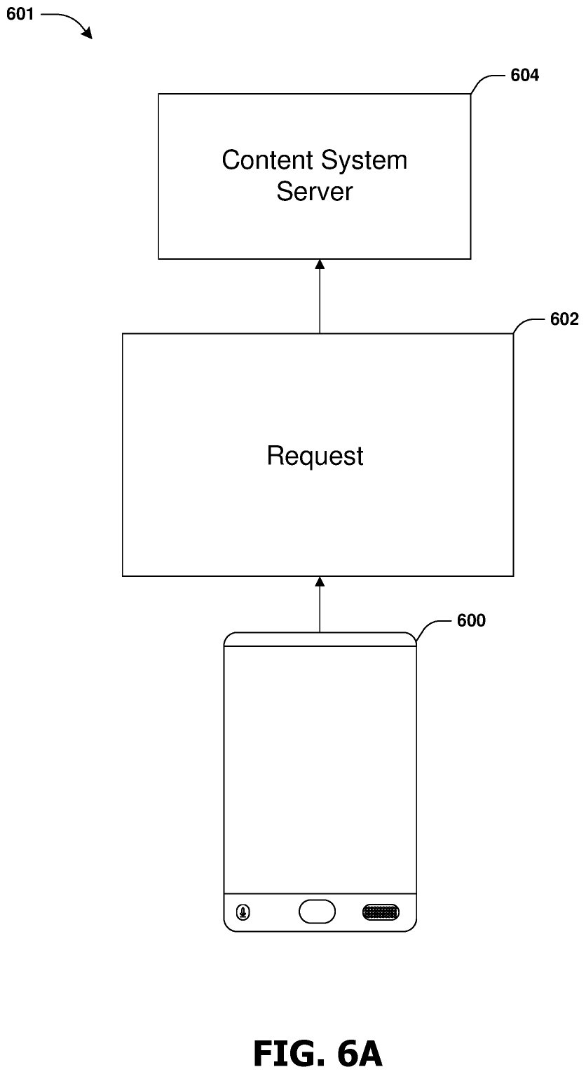

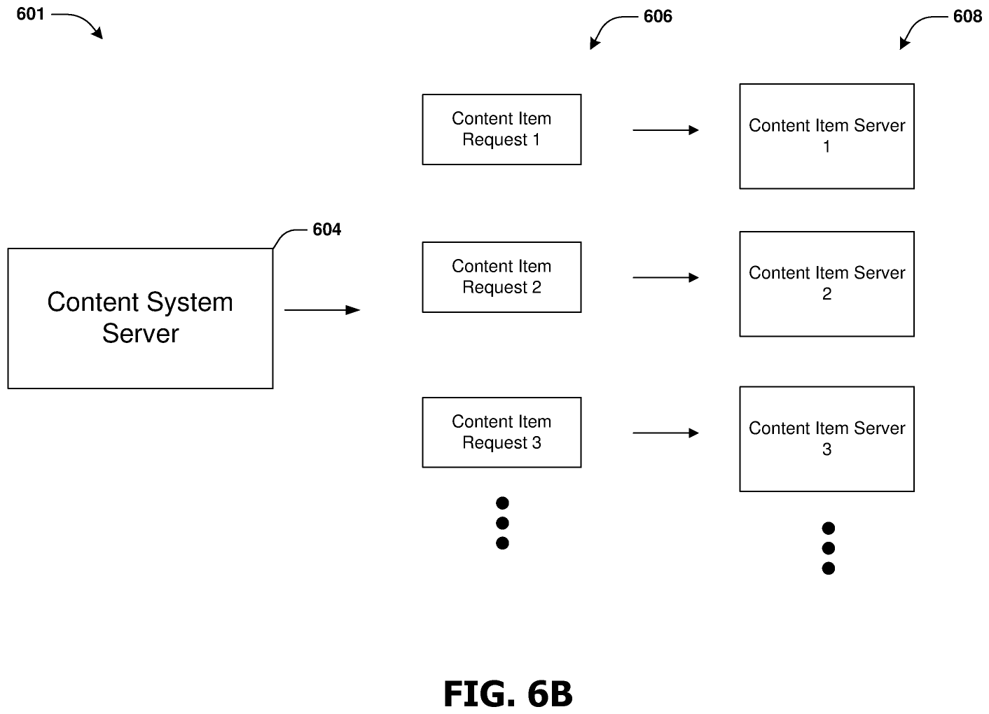

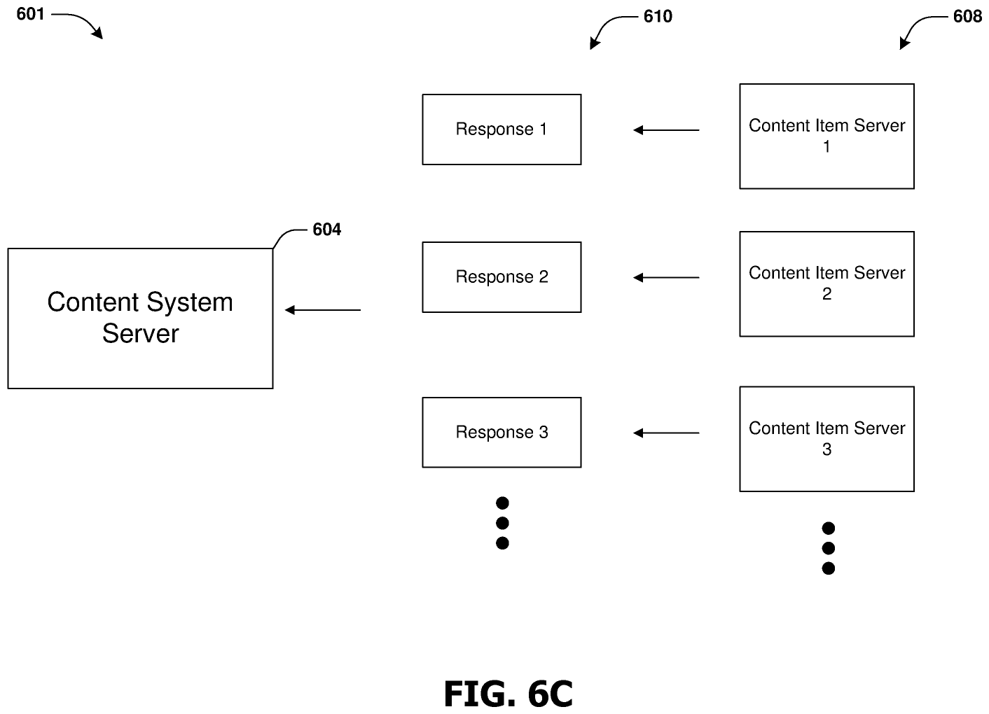

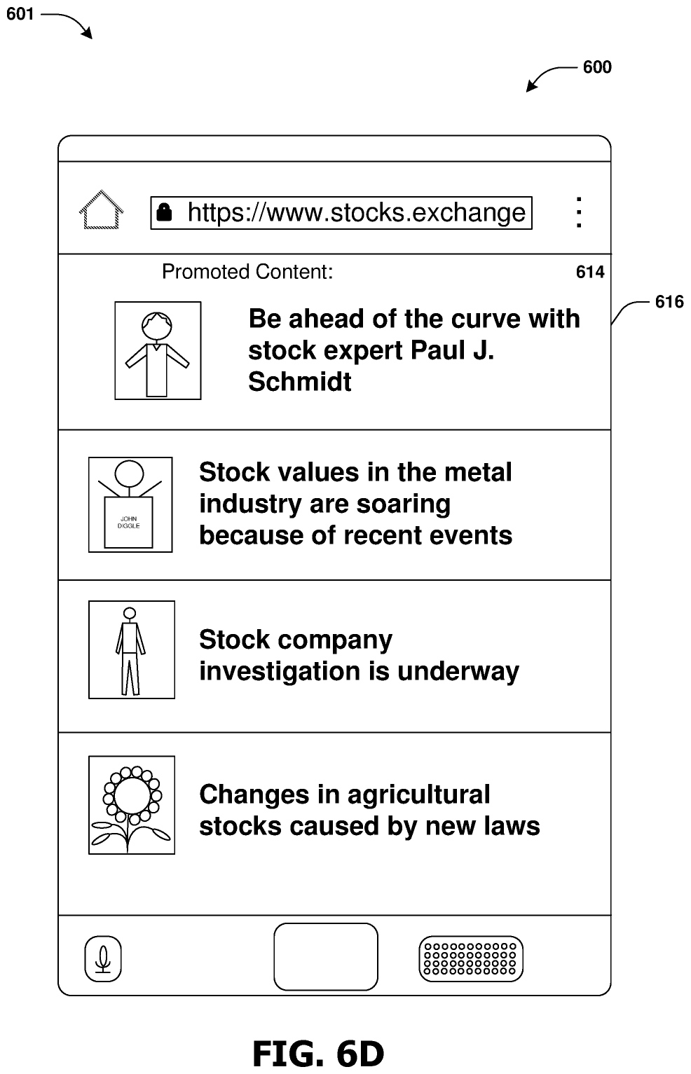

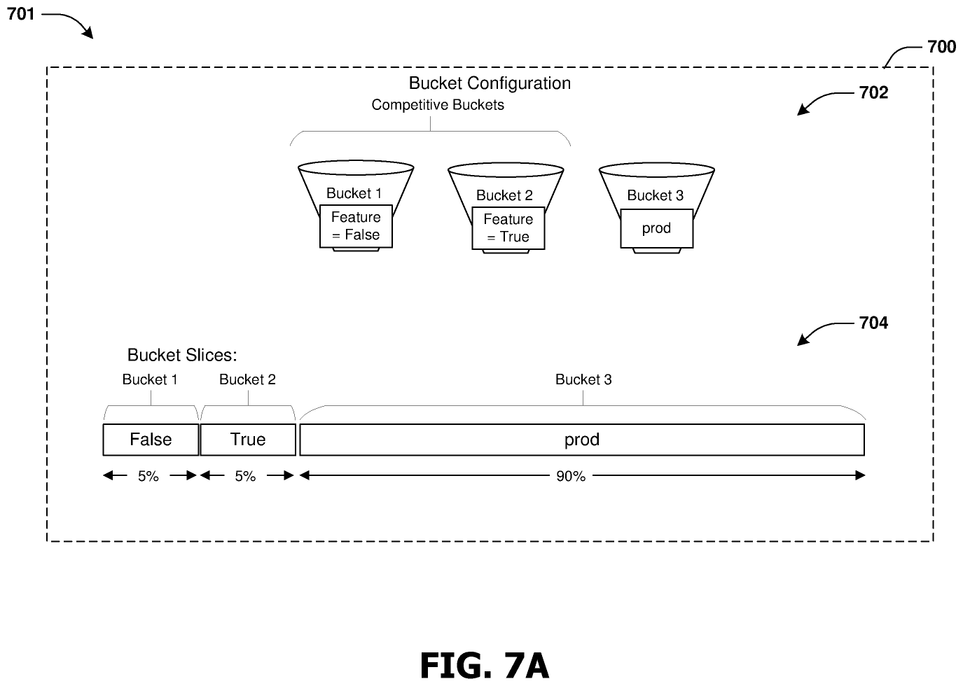

FIGS. 6A-6D illustrate an example system 601 for providing content to client devices. In some examples, a content system is provided. The content system may be an advertisement system. Alternatively and/or additionally, the content system may provide content items to be presented via pages associated with the content system. For example, the pages may be associated with websites (e.g., websites providing search engines, email services, news content, communication services, etc.) associated with the content system. The content system may provide content items to be presented in (dedicated) locations throughout the pages (e.g., one or more areas of the pages configured for presentation of content items). For example, a content item may be presented at the top of a web page associated with the content system (e.g., within a banner area), at the side of the web page (e.g., within a column), in a pop-up window, overlaying content of the web page, etc. Alternatively and/or additionally, a content item may be presented within an application (e.g., a mobile application) associated with the content system and/or within a game associated with the content system. Alternatively and/or additionally, a user may be required to watch and/or interact with the content item before the user can access content of a web page, utilize resources of an application and/or play a game.

A first user, such as user Jill, (and/or a first client device associated with the first user) may access and/or interact with a service, such as a browser, software, a website, an application, an operating system, an email interface, a messaging interface, a music-streaming application, a video application, a news application, etc. that provides a platform for viewing and/or downloading content from a server associated with the content system. In some examples, the content system may use user information, such as a first user profile comprising activity information (e.g., search history information, website browsing history, email information, selected content items, etc.), demographic information associated with the first user, location information, etc. to determine interests of the first user and/or select content for presentation to the first user based upon the interests of the first user.

FIG. 6A illustrates a server 604 of the content system receiving a request 602 (e.g., a request for content) associated with the first client device (shown with reference number 600). The request 602 may correspond to a request to be provided with one or more content items (e.g., advertisements, images, links, videos, etc.) for presentation via a first internet resource, such as in one or more serving areas of the first internet resource. The first internet resource corresponds to at least one of a web page of a website associated with the content system, an application associated with the content system, an internet game associated with the content system, etc.

In some examples, the first client device 600 may transmit a request to access the first internet resource to a first server associated with the first internet resource. In response to receiving the request to access the first internet resource, the first server associated with the first internet resource may transmit first resource information associated with the first internet resource to the first client device 600. The first client device 600 may transmit the request 602 to the content system (e.g., to the server 604 of the content system) in response to receiving the first resource information. Alternatively and/or additionally, the first server associated with the first internet resource may transmit the request 602 to the content system in response to receiving the request to access the first internet resource.

In some examples, in response to receiving the request 602, the content system may transmit one or more content item requests to one or more content item servers. For example, a content item request of the one or more content item requests may correspond to a request for a content item server to provide a content item (e.g., an advertisement, an image, a link, a video, etc.) and/or a bid value for participation in a first auction associated with the request 602.

FIG. 6B illustrates the server 604 of the content system transmitting content item requests 606 to content item servers 608. In some examples, a content item server of the content item servers 608 may correspond to a supply-side server and/or a content exchange (e.g., an ad exchange). In an example, the content item requests 606 comprise Content Item Request 1 transmitted to Content Item Server 1, Content Item Request 2 transmitted to Content Item Server 2, Content Item Request 3 transmitted to Content Item Server 3, etc. In some examples, the content item requests 606 may be indicative of first information associated with the request 602, the first internet resource and/or the first client device 600. In an example, the first information indicated by the content item requests 606 may comprise (i) a domain name of the first internet resource associated with the request 602, (ii) a top-level domain associated with the first internet resource, (iii) at least some of a web address of the first internet resource, (iv) a time associated with the request 602 (e.g., a time of transmission of the request 602), (v) a location associated with the first client device 600 (e.g., at least one of a region, a state, a province, a country, etc. associated with the first client device 600), (vi) a device identifier associated with the first client device 600, (vii) an IP address associated with the first client device 600, (viii) a carrier identifier indicative of carrier information associated with the first client device 600, (ix) a user identifier (e.g., at least one of a username associated with a first user account associated with the first client device 600, an email address, a user account identifier, etc.) associated with the first user and/or the first client device 600, (x) a browser cookie, and/or (xi) other information.

In some examples, in response to receiving Content Item Request 1, Content Item Server 1 of the content item servers 608 may (i) use the first information (indicated by Content Item Server 1, for example) to select a first content item and/or determine a first bid value associated with the first content item, and/or (ii) send a response, to the content system, indicative of the first content item and/or the first bid value. In some examples, Content Item Request 1 is indicative a timeout value, which may correspond to a duration of a window of time within which a response to Content Item Request 1 should be submitted to the content system (e.g., Content Item Request 1 may be canceled when the window of time ends). A starting time of the window of time may correspond to a time at which Content Item Request 1 is transmitted by the server 604 of the content system, a time at which Content Item Request 1 is received by Content Item Server 1, and/or another time. The window of time may end when the duration corresponding to the timeout value has elapsed after the starting time. In an example in which the timeout value corresponds to 10 milliseconds, the window of time (within which a response to Content Item Request 1 is expected by the content system, for example) may end 10 milliseconds after Content Item Request 1 is transmitted by the server 604 of the content system and/or received Content Item Server 1.

FIG. 6C illustrates the server 604 of the content system receiving responses 610 from the content item servers 608. In some examples, each response of one, some and/or all of the responses 610 is submitted by a content item server in response to a content item request (of the content item requests 606), and the response may be submitted in accordance with (e.g., within a window of time derived from) a timeout value indicated by the content item request. For example, Content Item Server 1 may submit Response 1 (indicative of the first content item and/or the first bid value, for example) to the server 604 of the content system in response to Content Item Request 1 within the window of time derived from the timeout value indicated by Content Item Request 1.

In some examples, bid values indicated by the responses 610 may be included in the first auction associated with the request 602. In some examples, the content system may analyze a plurality of bid values participating in the first auction to identify a winner of the first auction. In some examples, the content system may determine that the first bid value (indicated by Response 1, for example) and/or the first content item associated with the first bid value are the winner of the first auction based upon a determination that the first bid value is a highest bid value of the plurality of bid values.

In some examples, in response to determining that the first bid value and/or the first content item (e.g., an advertisement, an image, a link, a video, etc.) associated with the first bid value are the winner of the first auction, the first content item may be transmitted to the first client device 600. FIG. 6D illustrates the first client device 600 presenting and/or accessing the first internet resource, which may correspond to a web page 614. For example, the content system may provide the first content item (shown with reference number 616) to be presented via the web page 614 while the web page 614 is accessed by the first client device 600.

Referring back to FIGS. 5A-5E, the processes 522, the second process 560, etc. may comprise transmitting content item requests using one or more of the techniques provided herein with respect to FIGS. 6A-6D. In an example, the one or more first features (associated with Profile A of Bucket 1, Profile B of Bucket 2, Profile C of Bucket 3 and/or Profile D of Bucket 4, for example) may be correspond to one or more settings, one or more parameters, etc. associated with (i) reception of requests (e.g., the request 602 in FIG. 6A) associated with client devices, (ii) transmission of content item requests (e.g., the content item requests 606 in FIG. 6B) to content item servers (e.g., supply-side servers and/or content exchanges), (iii) reception of responses (e.g., the responses 610 in FIG. 6C) from content item servers, (iv) selection of content for transmission to client devices, and/or (v) providing selected content to client devices (e.g., presenting the first content item 616 on the first client device 600). In some examples, the first application may be used by the content system to perform one, some and/or all of the techniques shown in and/or described with respect to FIGS. 6A-6D.

In some examples, the one or more first features may correspond to a timeout value indicated by a content item request (e.g., the content item requests 606 in FIG. 6B) to a content item server. In some examples, each bucket of the first plurality of buckets 502 (and/or each bucket of the set of competitive buckets) may be associated with a timeout value. For example, and/or Profile A associated with Bucket 1 may be indicative of a first timeout value, Profile B associated with Bucket 2 may be indicative of a second timeout value, Profile C associated with Bucket 3 may be indicative of a third timeout value and/or Profile D associated with Bucket 4 may be indicative of a fourth timeout value (e.g., a default timeout value).

Referring back to FIG. 5B, the processes 522 performed in the first evaluation period may correspond to content item request processes in which the content system transmits content item requests (e.g., the content item requests 606 in FIG. 6B) to content item servers. The first plurality of processes 506 may comprise transmitting a first plurality of content item requests (assigned to Bucket 1, for example). The first plurality of content item requests may be generated and/or transmitted according to Profile A. For example, the first plurality of content item requests may be indicative of the first timeout value. Alternatively and/or additionally, the second plurality of processes 508 may comprise transmitting a second plurality of content item requests (assigned to Bucket 2, for example). The second plurality of content item requests may be generated and/or transmitted according to Profile B. For example, the second plurality of content item requests may be indicative of the second timeout value.

In some examples, the first evaluation metrics 530 (shown in FIG. 5C) may be determined based upon responses (e.g., the responses 610 in FIG. 6C) and/or other signals received by the content system from content item servers. In some examples, the Bucket 1 Metrics (of the first evaluation metrics 530) associated with Bucket 1 may be indicative of (i) a first response latency metric associated with reception of one or more responses to one or more content item requests of the first plurality of content item requests, (ii) a first measure of responses associated with the first plurality of content item requests, and/or (iii) one or more other metrics associated with the first plurality of content item requests. In some examples, the first response latency metric may be determined based upon response latencies of responses (received by the content system) transmitted in response to the first plurality of content item requests. For example, the response latencies may be combined (e.g., averaged) to determine the first response latency metric. In some examples, a response latency of a response may correspond to a duration of time between a time when the content system transmits a content item request to a content item server and a time when the content system receives a response, from the content item server, that is in response to the content item request. In some examples, the first measure of responses may correspond to a response rate for the first plurality of content item requests, which may be based upon a total quantity of the first plurality of content item requests and/or a quantity of responses (indicative of content items and/or bid values) received in response to the content items of the first plurality of content item requests. In some examples, a lower value of the first measure of responses may indicate that content item servers are having difficulty providing responses within the window of time according to the first timeout value.

In some examples, the first bucket scores 532 may be determined based upon the first evaluation metrics 530. For example, the Bucket 1 Score may be determined based upon the Bucket 1 Metrics. In some examples, the Bucket 1 Score may be a function of the first response latency metric, wherein a lower value of the first response latency metric may correspond to a higher value of the Bucket 1 Score (e.g., lower latency is preferred). In some examples, the Bucket 1 Score may be a function of the first measure of responses, wherein a higher value of the first measure of responses may correspond to a higher value of the Bucket 1 Score (e.g., higher response rate is preferred).

Referring back to FIG. 5C, selecting 534 Bucket 2 based upon the Bucket 2 Score being the highest score among the first bucket scores 532 may indicate that using the second timeout value (according to Profile B) in content item request processes during the first evaluation period provides for the highest performance level among timeout values tested using the first plurality of buckets 502. In some examples, in response to selecting 534 Bucket 2, Profile D may be modified by modifying the fourth timeout value indicated by Profile D to a modified timeout value based upon the second timeout value indicated by Profile B. In response to modifying Profile D to the modified version of Profile D comprising the modified timeout value, the modified timeout value may be used for content item requests assigned to Bucket 4. For example, the eighth plurality of processes 558 (in FIGS. 5D and 5E) assigned to Bucket 4 in the second evaluation period may comprise transmitting content item requests indicative of the modified timeout value to content item servers. In some examples, the modified timeout value (used for content item request processes assigned to Bucket 2) may be equal to the second timeout value indicated by Profile B (e.g., Profile D may be modified by modifying the fourth timeout value of Profile D to the second timeout value).

In some examples, the second evaluation metrics may be determined based upon at least some of the second processes 560 (associated with the second evaluation period, for example). In some examples, the bucketing system may select a bucket based upon the second evaluation metrics and/or based upon the second bucket scores determined based upon the second evaluation metrics. In some examples, if the selected bucket is Bucket 4 (e.g., the production bucket), the bucketing system may not modify Profile D associated with Bucket 4 (e.g., may not further modify the modified version of Profile D) in response to the selection. In some examples, if the selected bucket is another bucket (e.g., Bucket 1, Bucket 3) other than Bucket 4 and has a profile indicating a timeout value different than the modified timeout value indicated by the modified version of Profile D, the bucketing system may modify Profile D to a second modified version indicating a second modified timeout value (different than the timeout value, for example).

In an example in which the selected bucket is Bucket 3, in response to selecting Bucket 3, the bucketing system may modify Profile D associated with Bucket 4 (e.g., the production bucket) based upon Profile C associated with Bucket 3. For example, the bucketing system may generate the second modified version of Profile D based upon Profile C. The second modified timeout value indicated by the second modified version of Profile D may be based upon (e.g., equal to) the third timeout value indicated by Profile C. In some examples, after modifying Profile D based upon Profile C to generate the second modified version of Profile D, content item requests assigned to Bucket 4 may be generated to indicate the second modified timeout value.

Thus, in accordance with some embodiments, the first optimization process may be implemented to automatically optimize the timeout value of the content system. For example, the timeout value of Bucket 4 may be updated (e.g., periodically updated) via optimization cycles of the first optimization process.

In some examples, the bucketing system may modify one or more profiles of one or more buckets of the first plurality of buckets 502. For example, the one or more profiles may be modified based upon one or more trends identified by the bucketing system. In an example, the bucketing system may identify a trend in which bucket(s) of a first subset of the first plurality of buckets 502 are being selected more often than bucket(s) of a second subset of the first plurality of buckets 502. In some examples, the first subset of the first plurality of buckets 502 may be associated with a first range of timeout values (e.g., 1 second to 3 second timeout) and the second subset of the first plurality of buckets 502 may be associated with a second range of timeout values (e.g., 3 second to 5 second timeout). In some examples, in response to identifying the trend, the bucketing system may modify a profile of a bucket associated with the second range of timeout values from a timeout value within the second range to a modified timeout value within the first range (so as to increase a granularity of timeout values within the first range which may increase an accuracy of the first optimization process, for example). Alternatively and/or additionally, in response to identifying the trend, the bucketing system may add one or more buckets associated with one or more timeout values within the first range to the first plurality of buckets 502 (so as to increase a granularity of timeout values within the first range which may increase an accuracy of the first optimization process, for example). In an example in which the first subset includes a bucket for 1 second timeout and a bucket for 3 second timeout, the bucketing system may add a bucket for 2 second timeout to the first subset to increase a granularity of timeout values with respect to the first range.

In an example implementation of the first plurality of buckets 502, the first timeout value (indicated by Profile A) associated with Bucket 1 may correspond to a 1 second timeout, the second timeout value (indicated by Profile B) associated with Bucket 2 may correspond to a 1.5 second timeout, the third timeout value (indicated by Profile C) associated with Bucket 3 may correspond to a 2 second timeout, and/or the fourth timeout value (indicated by Profile D) associated with Bucket 4 may correspond to a predefined (e.g., default) timeout, such as 1 second (which may be equal to the first timeout value associated with Bucket 1, for example). Other implementations are within the scope of the present disclosure. For example, timeout values associated with the first plurality of buckets 502 may correspond to any timeout values. In another example implementation, the first plurality of buckets 502 may comprise buckets for timeout values corresponding to 1 second timeout, 1.2 second timeout, 1.5 second timeout, 1.7 second timeout, and 2 second timeout, respectively (e.g., the first plurality of buckets 502 may comprise a bucket associated with 1 second timeout, a bucket associated with 1.2 second timeout, a bucket associated with 1.5 second timeout, a bucket associated with 1.7 second timeout, and/or a bucket associated with 2 second timeout).

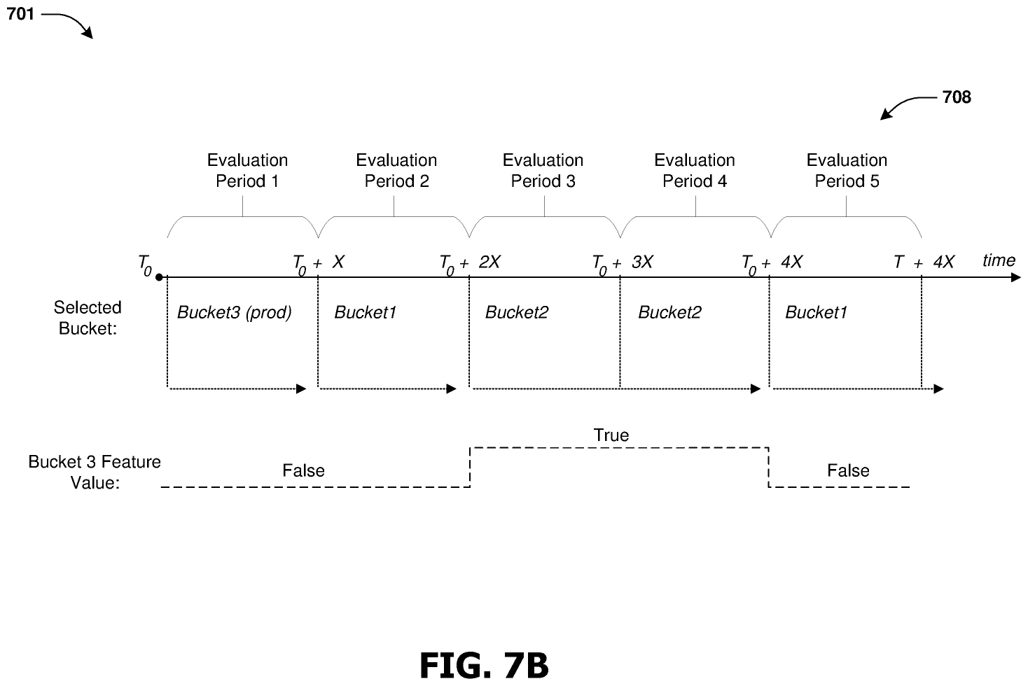

FIGS. 7A-7B illustrate an example system 701 for implementing a plurality of buckets to evaluate one or more profiles and/or optimize one or more features. FIG. 7A illustrates an example of a second bucket configuration 700 of a plurality of buckets 702 comprising a first bucket “Bucket 1”, a second bucket “Bucket 2” and/a third bucket “Bucket 3”. In some examples, Bucket 3 may correspond to a production bucket whose profile and/or configuration may be controlled based upon performance of processes assigned to Bucket 1 and Bucket 2 (e.g., Buckets 1 and 2 may correspond to competitive buckets of the plurality of buckets 702). In an example, a bucket slice representation 704 shows a first target proportion of 5% for Bucket 1, a second target proportion of 5% for Bucket 2, and/or a third target proportion of 90% for Bucket 3 (e.g., the production bucket).

In some examples, the second bucket configuration 700 may comprise a configuration of a plurality of profiles associated with the plurality of buckets 702. For example, each bucket of one, some and/or all of the plurality of buckets 702 may be configured with a profile of the plurality of profiles. For example, Bucket 1 may be configured with a first profile indicating that a third feature (e.g., a third feature of the first application) is a first value (e.g., “false”), Bucket 2 may be configured with a second profile indicating that the third feature is a second value (e.g., “true”), and/or Bucket 3 may be configured with a third profile indicating a third value (e.g., a predefined value, such as a default value, for the production bucket). In the example shown in FIGS. 7A-7B, the first value associated with Bucket 1 corresponds to “false” (e.g., processes assigned to Bucket 1 may be performed with the third feature of the first application disabled), the second value associated with Bucket 2 corresponds to “true” (e.g., processes assigned to Bucket 2 may be performed with the third feature of the first application disabled), and/or the third value (e.g., the predefined value) associated with Bucket 3 corresponds to “false”.

FIG. 7B illustrates a timing diagram of an example scenario 708 associated with running a third optimization process using the plurality of buckets 702. In some examples, optimization cycles of the third optimization process are associated with evaluation periods each having a duration of X seconds. In some examples, evaluations of the plurality of buckets 702 (e.g., evaluations in which evaluation metrics of the plurality of buckets 702 are analyzed to select a winning bucket and/or update Bucket 3 based upon the winning bucket) are performed periodically at an evaluation frequency of about 1/X evaluations per second. In an example, X corresponds to 30 seconds, 60 seconds, 300 seconds, 600 seconds, or other value.

In an example, the third optimization process comprises (i) a first optimization cycle associated with Evaluation Period 1 from time T₀ to time T₀+X, (ii) a second optimization cycle associated with Evaluation Period 2 from time T₀+X to time T₀+2X, (iii) a third optimization cycle associated with Evaluation Period 3 from time T₀+2X to time T₀+3X, (iv) a fourth optimization cycle associated with Evaluation Period 4 from time T₀+3X to time T₀+4X, and/or (v) a fifth optimization cycle associated with Evaluation Period 5 from time T₀+4X to time T₀+5X.

In the example shown in FIGS. 7A-7B, the first value associated with Bucket 1 corresponds to “false”, the second value associated with Bucket 2 corresponds to “true”, and/or the third value (e.g., the predefined value) associated with Bucket 3 corresponds to “false”.

In some examples, in Evaluation Period 1, the third profile associated with Bucket 3 (e.g., the production bucket) may be set to “false” (e.g., the third value). For example, the third profile may be initialized to “false” when the third optimization process is initiated by the bucketing system. Accordingly, for processes assigned to Bucket 3 in Evaluation Period 1, the third feature may be set to “false”. For example, processes assigned to Bucket 3 in Evaluation Period 1 may be performed with the third feature disabled. In an example, the third feature may correspond to a functionality, a setting, etc., such as at least one of a video display feature (e.g., a brightness modulation feature, an image processing function configured to enhance a video, etc.), a content selection feature (e.g., a module that performs at least a part of a content selection process to select content to present to a user), etc.

In the example shown in FIG. 7B, the bucketing system may select Bucket 1 as a winning bucket for Evaluation Period 2 (e.g., the bucketing system may select Bucket 1 based upon an evaluation of processes performed in Evaluation Period 1). Accordingly, since the winning bucket (e.g., Bucket 1) corresponds to “false”, the third profile associated with Bucket 3 (e.g., the production bucket) may be set to “false” in Evaluation Period 2 (e.g., “Bucket 3 Feature Value” may be set to “false” in FIG. 7B). For example, processes assigned to Bucket 3 in Evaluation Period 2 may be performed with the third feature disabled. The bucketing system may select Bucket 2 as the winning bucket for Evaluation Period 3 (e.g., the bucketing system may select Bucket 2 based upon an evaluation of processes performed in Evaluation Period 2). Accordingly, since the winning bucket (e.g., Bucket 2) corresponds to “true”, the third profile associated with Bucket 3 (e.g., the production bucket) may be set to “true” in Evaluation Period 3. For example, processes assigned to Bucket 3 in Evaluation Period 3 may be performed with the third feature enabled. The bucketing system may select Bucket 2 as the winning bucket for Evaluation Period 4 (e.g., the bucketing system may select Bucket 2 based upon an evaluation of processes performed in Evaluation Period 3). Accordingly, since the winning bucket (e.g., Bucket 2) corresponds to “true”, the third profile associated with Bucket 3 (e.g., the production bucket) may be set to “true” in Evaluation Period 4. For example, processes assigned to Bucket 3 in Evaluation Period 4 may be performed with the third feature enabled. The bucketing system may select Bucket 1 as the winning bucket for Evaluation Period 5 (e.g., the bucketing system may select Bucket 1 based upon an evaluation of processes performed in Evaluation Period 4). Accordingly, since the winning bucket (e.g., Bucket 1) corresponds to “false”, the third profile associated with Bucket 3 (e.g., the production bucket) may be set to “false” in Evaluation Period 5. For example, processes assigned to Bucket 3 in Evaluation Period 5 may be performed with the third feature disabled.

In some examples, in at least some of the third optimization process, merely some of the plurality of buckets 702 are activated concurrently. In some examples, a bucket with a profile that matches a profile of another (activated) bucket may be deactivated (since the bucket is redundant in light of the other bucket with the matching profile, for example). In an example with respect to FIGS. 7A-7B, merely one of Bucket 1 or Bucket 3 may be activated in Evaluation Period 1 since both Bucket 1 and Bucket 3 correspond to “false”. In a first example, Bucket 1 may be deactivated and Bucket 3 may be activated in Evaluation Period 1. In another example, Bucket 1 may be activated and Bucket 3 may be deactivated in Evaluation Period 1.

Alternatively and/or additionally, in an initial evaluation period of an optimization process, bucket slices may be split (e.g., evenly or unevenly) between a set of competitive buckets of the optimization process, and a production bucket of the optimization process may be initialized for a subsequent evaluation period based upon a winning bucket of the initial evaluation period (e.g., the winning bucket may correspond to whichever bucket is selected from the set of competitive buckets of the optimization process based upon evaluation metrics associated with the initial evaluation period). For example, the production bucket may be deactivated for the initial evaluation period (until the winning bucket is selected, for example). In an example with respect to FIGS. 7A-7B, in Evaluation Period 1, Bucket 1 and Bucket 2 may be activated and Bucket 3 may be deactivated. In an example, Bucket 1 and Bucket 2 may each have a target proportion of 50% for Evaluation Period 1 (since Bucket 3 is deactivated, for example). In some examples, the third profile of Bucket 3 may be initialized to “false” for Evaluation Period 2. For example, the third profile of Bucket 3 may be initialized to “false” based upon the selection of Bucket 1 as the winning bucket for Evaluation Period 2 (e.g., the bucketing system may select Bucket 1 based upon an evaluation of processes performed in Evaluation Period 1). In some examples, in Evaluation Period 2, since both Bucket 1 and Bucket 3 correspond to “false”, merely one of Bucket 1 or Bucket 3 may be activated in Evaluation Period 2.

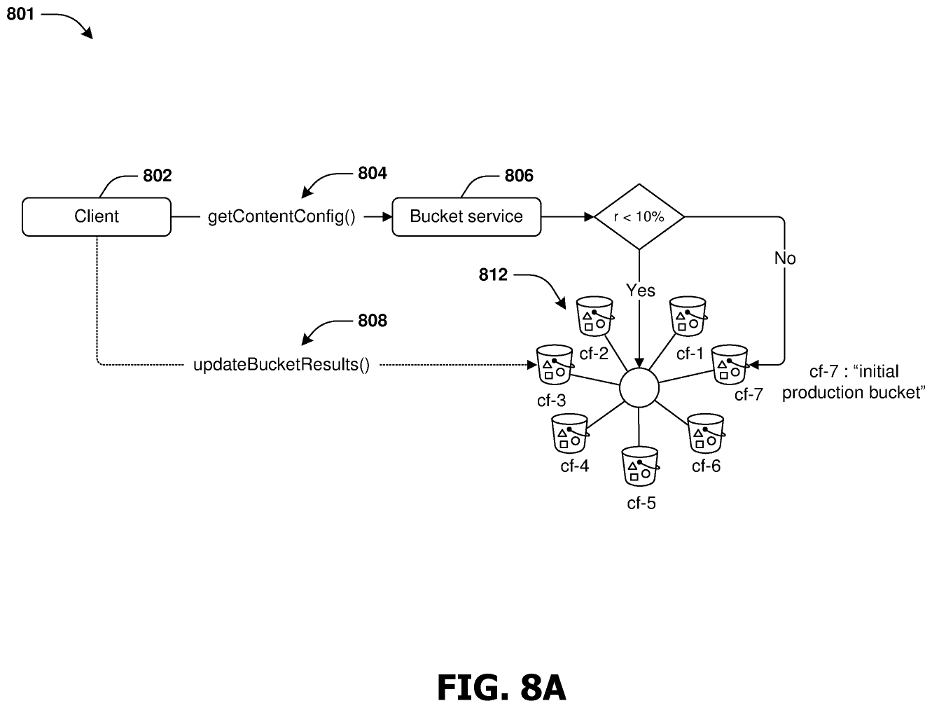

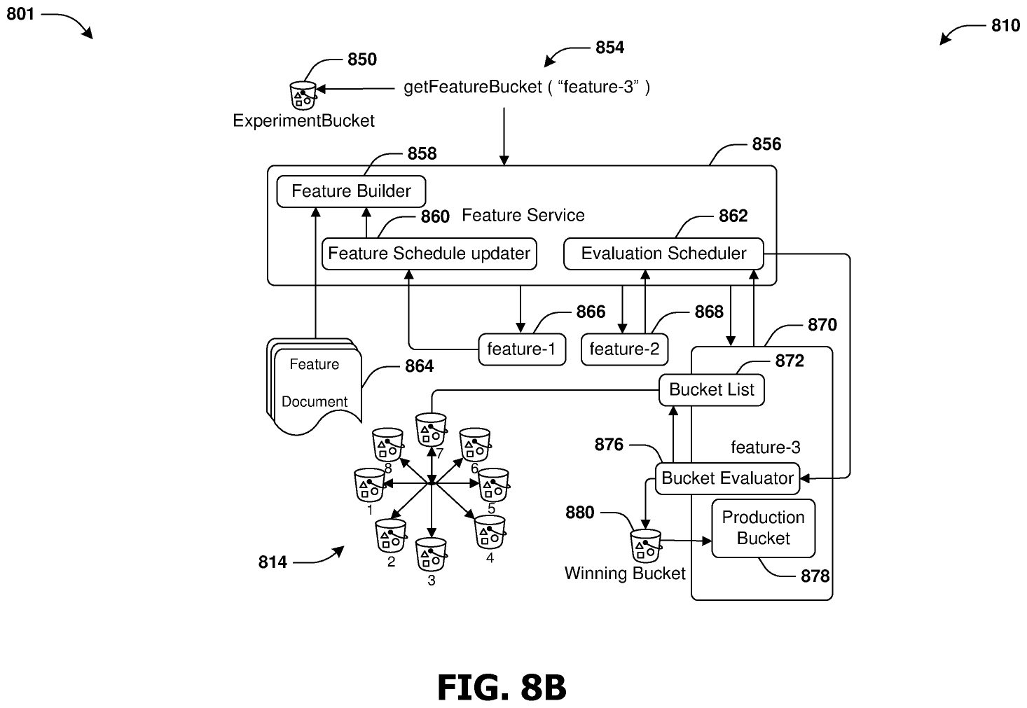

FIGS. 8A-8B illustrate an example system 801 for implementing a plurality of buckets to evaluate one or more profiles and/or optimize one or more features. FIG. 8A illustrates an exemplary scenario of a client 802 triggering a bucket service 806 to assign web traffic corresponding to processes (e.g., content item request processes, video streaming processes, etc.) to a plurality of buckets 812. Although seven buckets are shown in FIG. 8A, it may be appreciated that the plurality of buckets 812 may comprise any quantity of buckets, such as two, three, four, five, six, seven, eight, nine, ten, fifteen, twenty, or other quantity of buckets. For example, the client 802 may provide a bucket configuration 804 (e.g., the first bucket configuration 500, the second bucket configuration 700) for configuring the plurality of buckets 812. In some examples, the bucket configuration 804 may correspond to a configuration of buckets to use in a fourth optimization process for optimizing one or more fourth features (e.g., one or more fourth features of the first application or a different application). In an example, the client 802 may correspond to the content system discussed herein with respect to FIGS. 6A-6D, and/or one or more fourth features may correspond to one or more features (e.g., timeout values and/or other features) of a content item request process.

In some examples, the bucket configuration 804 may be indicative of a quantity of buckets (e.g., seven in FIG. 8A) of the plurality of buckets 812. In some examples, the bucket configuration 804 may be indicative of an evaluation frequency and/or a duration of time of evaluation periods of the fourth optimization process (e.g., a duration of time between evaluations of the fourth optimization process, such as a duration X in FIG. 7B).

In some examples, the second bucket configuration 700 may comprise a configuration of a plurality of profiles associated with the plurality of buckets 812. For example, each bucket of one, some and/or all of the plurality of buckets 812 may be configured with a profile of the plurality of profiles. In some examples, the plurality of profiles may be associated with the one or more fourth features. In some examples, a profile of the plurality of profiles may comprise at least one of a configuration, one or more values, etc. for the one or more features, which may correspond to at least one of a timeout value of a content item request process, one or more video streaming parameters of a video streaming process, etc. In some examples, the plurality of profiles comprises different profiles. In some examples, buckets of the plurality of buckets 812 have different profiles. In some examples, no two buckets of the plurality of buckets 812 have matching (e.g., identical) profiles.

In some examples, the bucket configuration 804 may indicate that (i) a fifth target proportion of processes (e.g., a fifth target proportion of web traffic) be assigned to a production bucket of the plurality of buckets 812, and (ii) a sixth target proportion of processes (e.g., a sixth target proportion of web traffic) be distributed among experiment buckets of the plurality of buckets 812. In some embodiments, the experiment buckets comprise some or all of the plurality of buckets 812. For example, the experiment buckets may comprise remaining buckets, other than the production bucket, of the plurality of buckets 812. Alternatively and/or additionally, the experiment buckets may comprise (all of) the plurality of buckets 812 (including the production bucket).

In an example, the fifth target proportion of processes for the production bucket is 90% and the sixth target proportion of processes to be distributed among the experiment buckets may be 10%. Accordingly, in the example, a set of processes amounting to about 90% of processes of an evaluation period (e.g., about 90% of web traffic of the evaluation period) may be assigned to the production bucket, and/or processes amounting to about 10% of the processes of the evaluation period (e.g., about 10% of the web traffic of the evaluation period) may be distributed among the experiment buckets of the plurality of buckets 812. In some examples, the 10% of the processes of the evaluation period that is distributed among the experiment buckets may be split in approximately equal parts among the experiment buckets. In an example in which the plurality of buckets 812 includes 10 buckets and all of the 10 buckets (including the production bucket) are included in the experiment buckets, then each of the experiment buckets may be assigned about 1% of the processes of the evaluation period. In an example in which the plurality of buckets 812 includes seven buckets (such as shown in FIG. 8A) and the production bucket is not included in the experiment buckets (e.g., the production bucket is not assigned processes from the 10% of the processes of the evaluation period that is distributed among the experiment buckets), then each of the experiment buckets (e.g., remaining buckets other than the production bucket) may be assigned about 1.67% of the processes of the evaluation period (e.g., 10% of the processes split over six buckets).

Other values (other than 90%) of the fifth target proportion of processes are contemplated and/or other values (other than 10%) of the sixth target proportion of processes are contemplated. In an example, the fifth target proportion may be 70% and the sixth target proportion may be 30%. In an example, the fifth target proportion may be 80% and the sixth target proportion may be 20%. In an example, the fifth target proportion may be 85% and the sixth target proportion may be 15%. Other examples of the fifth target proportion and/or the sixth target proportion are within the scope of the present disclosure.

Alternatively and/or additionally, the bucket configuration 804 may be indicative of one or more bucket-specific target proportions associated with one or more buckets of the plurality of buckets 812. In an example, the one or more bucket-specific target proportions may comprise a bucket-specific target proportion associated with bucket cf-1. In some examples, when bucket cf-1 is not designated the production bucket, the bucketing system may assign processes to bucket cf-1 according to the bucket-specific target proportion.

In some examples, the bucket configuration 804 may be indicative of an initial production bucket. In some examples, the initial production bucket identifies a bucket, of the plurality of buckets 812, that is (automatically) designated the production bucket for an initial evaluation period of the fourth optimization process. In the example shown in FIG. 8A, the initial production bucket may be bucket cf-7 of the plurality of buckets 812. Accordingly, in the initial evaluation period of the fourth optimization process, the bucketing system may assign a set of processes amounting to about 90% (e.g., the fifth target proportion) of processes of the initial evaluation period (e.g., 90% of web traffic in the initial evaluation period) to bucket cf-7, and/or the bucketing system may distribute processes amounting to about 10% (e.g., the sixth target proportion) of the processes of the initial evaluation period among experiment buckets (e.g., some or all of the plurality of buckets 812).

In some examples, if the initial production bucket is not defined in the bucket configuration 804, processes of the initial evaluation period may be distributed (in approximately equal parts, for example) among the plurality of buckets 812. In some examples, the processes may be evaluated (based upon results 808, of the processes, received from the client 802, for example) to select a winning bucket to be the production bucket (for a subsequent evaluation period after the initial evaluation period, for example). Then, in the subsequent evaluation period, the bucketing system may assign a set of processes amounting to about 90% (e.g., the fifth target proportion) of processes of the subsequent evaluation period (e.g., 90% of web traffic in the subsequent evaluation period) to the production bucket (e.g., the winning bucket).

In some examples, at least some of the bucket configuration 804 may be configured based upon user-input information (received via one or more user interactions of a user with a user interface, for example). For example, at least one of the quantity of buckets of the plurality of buckets 812, the evaluation frequency of the fourth optimization process, the fifth target proportion, the sixth target proportion, and/or other characteristics of the plurality of buckets 812 and/or the fourth optimization process may be configurable and/or customizable to provide for implementations that suit a certain task and/or environment.

In an example scenario, in a first optimization cycle associated with a first evaluation period (e.g., the initial evaluation period) of the fourth optimization process, the bucketing system may (i) assign a set of processes amounting to about 90% of processes of the first evaluation period to bucket cf-7 (e.g., bucket cf-7 is designated the production bucket for the first evaluation period), and/or (ii) distribute processes amounting to about 10% of the processes of the first evaluation period among experiment buckets of the plurality of buckets 812. For example, processes assigned to bucket cf-7 may be performed according to a profile (e.g., a timeout value, one or more video streaming parameters, etc.) associated with bucket cf-7.

In some examples, evaluation metrics associated with the plurality of buckets 812 may be determined based upon the processes performed in the first evaluation period (e.g., the evaluation metrics may be determined based upon the results 808 received from the client 802). The evaluation metrics may be used to select a winning bucket as the production bucket for a second evaluation period following (e.g., directly following) the first evaluation period. In an example, bucket scores associated with the plurality of buckets 812 may be determined based upon the evaluation metrics, and/or the winning bucket may be selected based upon a determination that a bucket score of the winning bucket is the highest bucket score among the bucket scores.

In an example, the winning bucket may correspond to bucket cf-1 (e.g., the bucket cf-1 may be selected to be the production bucket for the second evaluation period). In a second optimization cycle associated with the second evaluation period (after the first evaluation period), the bucketing system may (i) assign a set of processes amounting to about 90% of processes of the second evaluation period to bucket cf-1 (e.g., since bucket cf-1 is designated the production bucket for the second evaluation period), and/or (ii) distribute processes amounting to about 10% of the processes of the second evaluation period to experiment buckets of the plurality of buckets 812. For example, processes assigned to bucket cf-1 may be performed according to a profile (e.g., a timeout value, one or more video streaming parameters, etc.) associated with bucket cf-1, which may be different than the profile associated with bucket cf-7 (e.g., may correspond to a different timeout value, a different video resolution, etc.).

In some examples, second evaluation metrics associated with the plurality of buckets 812 may be determined based upon processes performed in the second evaluation period (e.g., the evaluation metrics may be determined based upon the results 808 received from the client 802). The evaluation metrics may be used to select a second winning bucket as the production bucket for a third evaluation period following (e.g., directly following) the second evaluation period. In an example, bucket scores associated with the plurality of buckets 812 may be determined based upon the second evaluation metrics, and/or the second winning bucket may be selected based upon a determination that a bucket score of the second winning bucket is the highest bucket score among the bucket scores. In an example, the second winning bucket may correspond to bucket cf-3 (e.g., the bucket cf-3 may be selected to be the production bucket for the third evaluation period). In a third optimization cycle associated with the third evaluation period (after the second evaluation period), the bucketing system may (i) assign a set of processes amounting to about 90% of processes of the third evaluation period to bucket cf-3 (e.g., since bucket cf-3 is designated the production bucket for the third evaluation period), and/or (ii) distribute processes amounting to about 10% of the processes of the third evaluation period to experiment buckets of the plurality of buckets 812. For example, processes assigned to bucket cf-3 may be performed according to a profile (e.g., a timeout value, one or more video streaming parameters, etc.) associated with bucket cf-3.

In some examples, subsequent optimization cycles of the fourth optimization process following the first optimization cycle, the second optimization cycle and/or the third optimization cycle may be performed using one or more of the techniques provided herein with respect to the first optimization cycle, the second optimization cycle and/or the third optimization cycle of the fourth optimization process, and/or using other techniques provided herein. Accordingly, by performing the fourth optimization process, the production bucket may be (automatically and/or without manual intervention) periodically updated (e.g., switched between buckets of the plurality of buckets 812) based upon information (e.g., the results 808 of processes performed during a recent evaluation period) reflective of real-time conditions. Thus, when conditions change and/or cause a production bucket's performance level to worsen but another bucket's performance level to improve, the fourth optimization process may automatically identify the improved bucket and/or designate the improved bucket as the production bucket in place of the bucket whose performance level worsened. In an example scenario in which the fourth optimization process is performed to optimize a timeout value of a content item response process (discussed with respect to FIGS. 6A-6D, for example), conditions of content item servers may have an impact on how fast content item responses are submitted after they are requested, and thus, the fourth optimization process may automatically adapt to changing conditions of the content item servers (e.g., a bucket associated with a higher timeout value may be selected to be the production bucket when there is increased demand and/or the content item servers are operating more slowly, and/or a bucket associated with a lower timeout value may be selected to be the production bucket when there is reduced demand and/or the content item servers are operating more quickly).

In some examples, the fourth optimization process may be performed using one or more of the techniques provided herein with respect to the first optimization process, FIG. 4, FIGS. 5A-5E, FIGS. 6A-6D and/or FIGS. 7A-7B and/or other techniques provided herein.

In an example, the one or more fourth features may correspond to one or more video streaming parameters (e.g., a video resolution and/or a bit rate) of a video streaming process performed using the first application. Evaluation metrics used to evaluate the plurality of buckets 812 may be reflective of performance levels of video streaming processes using different profiles associated with the plurality of buckets 812. In an example, the evaluation metrics may comprise at least one of a buffering time, a lag length, a play length, a lag ratio, etc. associated with a video streaming process. Accordingly, the evaluation metrics may be used to (accurately) select a winning bucket to be the production bucket for a subsequent evaluation period. Thus, periodically updating the production bucket in the fourth optimization process may improve a quality of video streaming processes performed using the first application.

In an example, the one or more fourth features may correspond to one or more data processing parameters of a process performed using the first application. Evaluation metrics used to evaluate the plurality of buckets 812 may be reflective of performance levels of processes using different profiles associated with the plurality of buckets 812. In an example, the evaluation metrics may comprise at least one of an energy usage metric (e.g., an amount of energy used to perform a process using a given profile), a processing power metric (e.g., an amount of processing power used to perform a process using a given profile), a memory usage metric (e.g., an amount of memory used to perform a process using a given profile), a bandwidth (e.g., a network bandwidth required to perform a process using a given profile), a speed (e.g., a speed with which a process using a given profile is performed), etc. Accordingly, the evaluation metrics may be used to (accurately) select a winning bucket to be the production bucket for a subsequent evaluation period. Thus, periodically updating the production bucket based upon the evaluation metrics may provide for at least one of more efficient energy usage, more efficient memory usage, more efficient bandwidth, increased speed, etc.

In an example, the one or more fourth features may correspond to one or more parameters of a web request (e.g., a Hypertext Transfer Protocol (HTTP) request or other type of request) performed using the first application. A web request may comprise at least one of a request for content, a request to access an internet resource, a request to be authenticated, etc. Evaluation metrics used to evaluate the plurality of buckets 812 may be reflective of performance levels of web requests using different profiles associated with the plurality of buckets 812. In an example, the evaluation metrics may comprise at least one of a speed (e.g., a speed with which responses are received to web requests transmitted according to a given profile), a success rate (e.g., a rate at which responses to web requests transmitted according to a given profile are successfully received), etc. Accordingly, the evaluation metrics may be used to (accurately) select a winning bucket to be the production bucket for a subsequent evaluation period. Thus, periodically updating the production bucket based upon the evaluation metrics may provide for improved processing and/or transmission of web requests.

It may be appreciated that by using the bucketing system to (i) distribute processes of the first application among the plurality of buckets 812, (ii) perform the processes according to profiles (e.g., different profiles) associated with the plurality of buckets 812, (iii) identify feedback (e.g., the results 808) associated with the processes performed according to the different profiles, and/or (iv) use the feedback to update the production bucket, the content system may implement a closed-loop process allowing usage of feedback to tailor and/or continuously and/or periodically update the production bucket used to perform at least some processes of the first application, thereby improving (e.g., continuously and/or periodically improving over time) a quality and/or accuracy of the first application. Closed-loop control may reduce errors and produce more efficient operation of a computer system which implements the bucketing system and/or the first application. The reduction of errors and/or the efficient operation of the computer system may improve operational stability and/or predictability of operation. Accordingly, using processing circuitry to implement closed loop control described herein may improve operation of underlying hardware of the computer system.

In some examples, the bucketing system may comprise a machine learning model used to perform the fourth optimization process. The machine learning model may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc. After training the machine learning model (using historical optimization information associated with one or more historical optimization processes, for example), feedback associated with processes of the first application performed in the fourth optimization process may be used to update the machine learning model. For example, in the closed-loop process, feedback associated with processes performed according to the profiles of the plurality of buckets 812 may be used to tailor and/or continuously and/or periodically update (e.g., optimize and/or train) the machine learning model, thereby improving (e.g., continuously and/or periodically improving over time) a quality and/or accuracy of optimization processes performed using the machine learning model.

FIG. 8B illustrates an example architecture 810 in which one, some and/or all of the techniques provided herein may be implemented. In some examples, a feature service 856 may comprise a feature builder 858, a feature schedule updater 860 and/or an evaluation scheduler 862. In some examples, the feature service 856 may be associated with a plurality of optimization processes comprising a feature-1 optimization process 866 for optimizing feature-1, a feature-2 optimization process 868 for optimizing feature-2 and/or a feature-3 optimization process 870 for optimizing feature-3. In some examples, one, some and/or all of the techniques provided herein may be used to perform one, some and/or all of the plurality of optimization processes. In some examples, the evaluation scheduler 862 may schedule evaluations for a plurality of buckets 814 of a bucket list 872 associated with the feature-3 optimization process 870 (e.g., the evaluations may be scheduled according to an evaluation frequency configured for the feature-3 optimization process 870). For example, the evaluations may be performed using a bucket evaluator 876, which may analyze evaluation metrics associated with the plurality of buckets 814 to select a winning bucket 880 and/or designate the winning bucket 880 as a production bucket 878 (e.g., the winning bucket 880 may be designated the production bucket 878 for a next evaluation period of the feature-3 optimization process 870). In some examples, information from the feature schedule updater 860 and/or feature information 864 (e.g., a feature document, such as a feature JavaScript Object Notation (JSON) document or other type of feature document) may be used as input by the feature builder 858 to configure one or more features and/or buckets for use in performing optimization processes to optimize the one or more features. In some examples, the client 802 may retrieve an experiment bucket 850 (of the plurality of buckets 814, for example) for the feature-3 optimization process 870 from the feature service 856 using a feature bucket retrieval function 854. In some examples, the client 802 may use the function to retrieve the experiment bucket 850 in response to identifying a process (and/or web traffic associated with the process). The experiment bucket 850 may be used for the process (e.g., web traffic) of the client 802. For example, the process may be performed according to a profile associated with the experiment bucket 850 retrieved from the feature service 856 for the process. In some examples, the results 808 provided by the client 802 are indicative of a result associated with the process performed using the profile associated with the experiment bucket 850, that may be used to determine evaluation metrics associated with the experiment bucket 850.

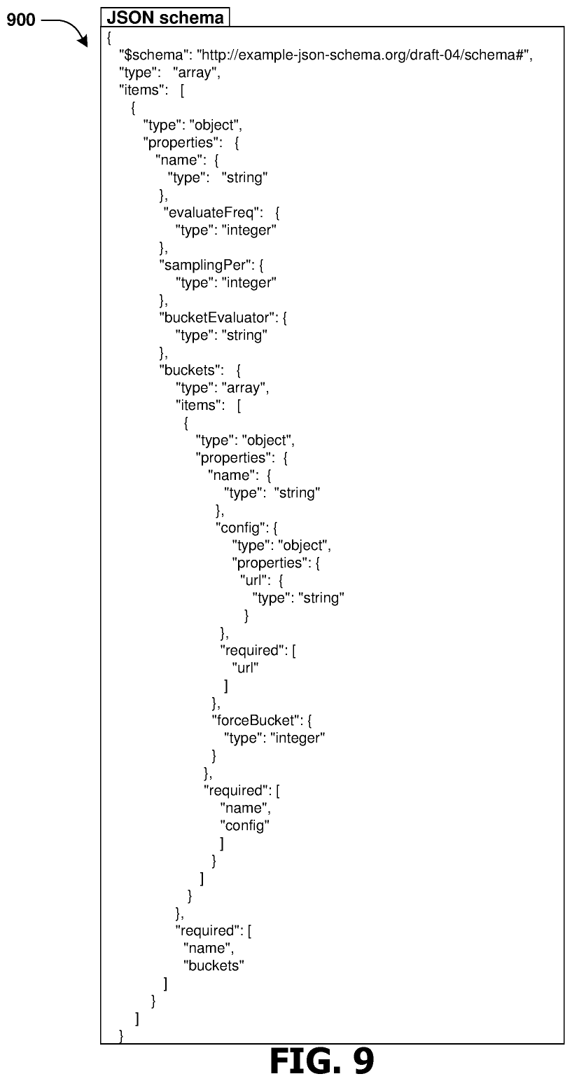

In some examples, the bucketing system may be implemented using software comprising one or more files (e.g., at least one of a software package, a jar file such as a Java jar file, etc.). FIG. 9 illustrates example code 900 of a computer program used to perform one or more of the techniques herein. In some examples, the example code 900 may be provided in JSON format. Other formats and/or computer languages of code associated with the bucketing system are within the scope of the present disclosure. In some examples, the example code 900 may provide a configuration of buckets for an optimization process of one or more features. In some examples, the example code 900 may define each bucket as an object (e.g., a JSON object) with a “name” (e.g., a name of the bucket), a “configuration” (e.g., a configuration of at least one of a profile, a target proportion, etc. associated with the bucket), and/or other information associated with the bucket (e.g., a minimum size, such as a minimum target proportion of processes assigned to the bucket in an evaluation period).

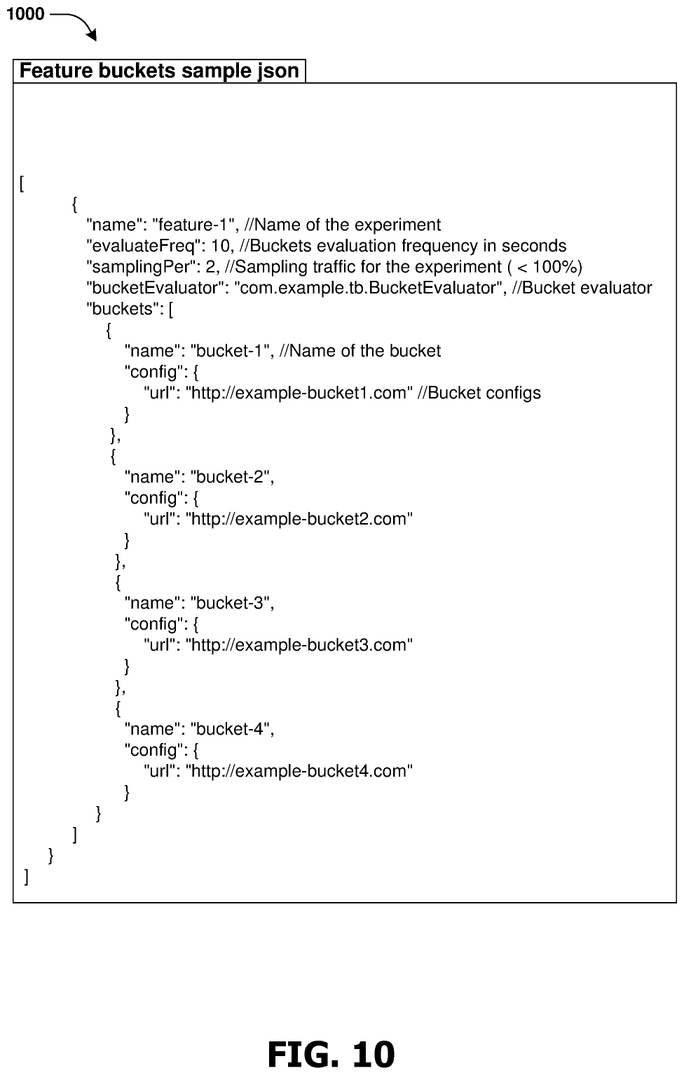

FIG. 10 illustrates example code 1000 of a computer program used to perform one or more of the techniques herein. In some examples, the example code 1000 may be provided in JSON format. In some examples, the example code 1000 defines a name of an optimization process. In FIG. 10, the name may be “feature-1” and/or the optimization process may correspond to the feature-1 optimization process 866 in FIG. 8B. In some examples, the example code 1000 defines an evaluation frequency associated with the feature-1 optimization process 866 (e.g., evaluations may be performed to select a winning bucket every 10 seconds). In some examples, the example code 1000 defines an experimental sampling proportion (e.g., sampling percentage) associated with the feature-1 optimization process 866. In some examples, the experimental sampling proportion may correspond to a target proportion of processes (e.g., a target proportion of web traffic) to be distributed among experiment buckets. In some examples, the feature-1 optimization process 866 may be referred to as an experiment (since the feature-1 optimization process 866 involves using buckets to test and/or monitor performance levels of different profiles, for example).

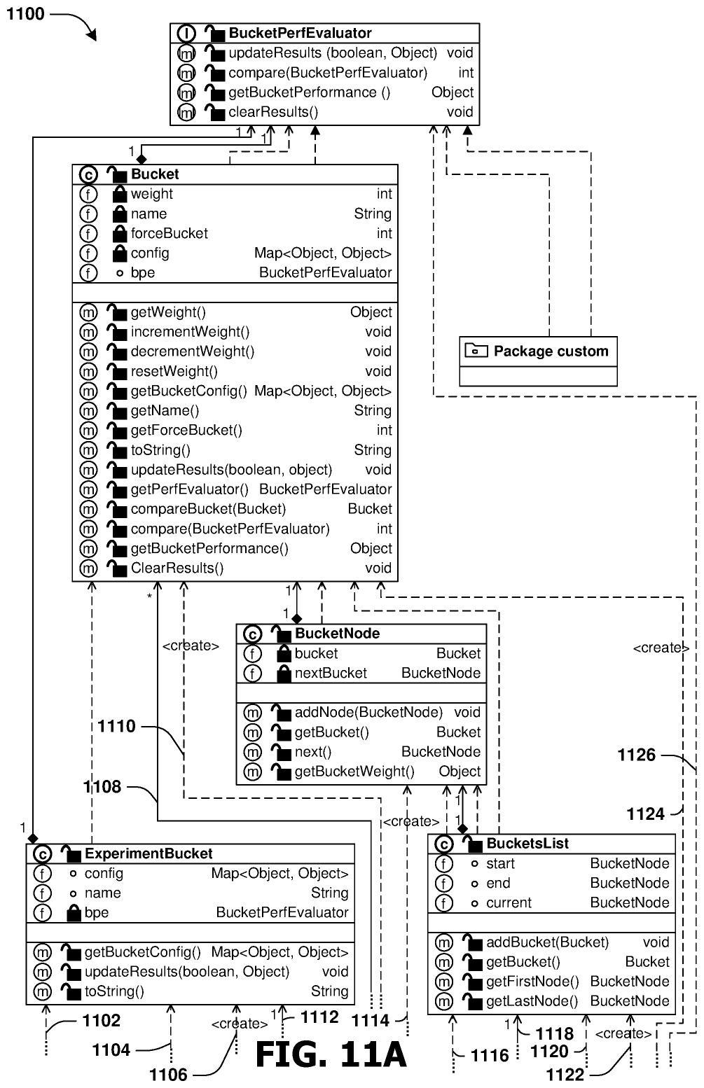

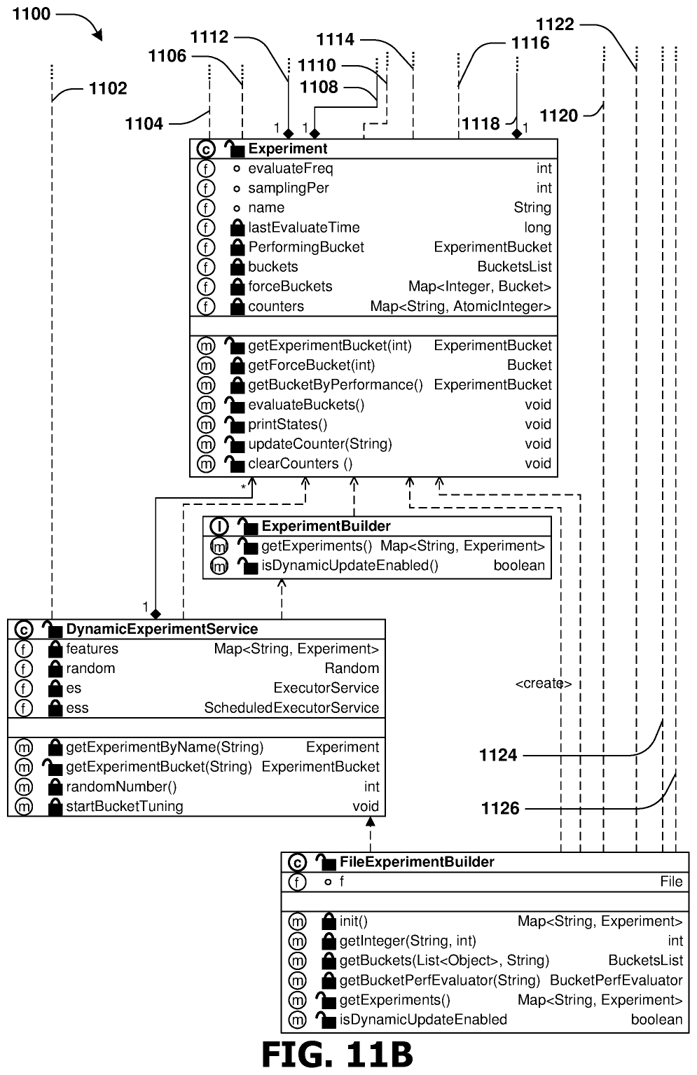

FIGS. 11A-11B illustrate an example class diagram 1100 of various example classes that may be used to perform one or more of the techniques herein. Some lines extend from FIG. 11A to FIG. 11B and/or vice versa. Lines sharing the same number in FIGS. 11A-11B are connected to each other (and/or are extensions of each other). In some examples, the classes may comprise a BucketPerfEvaluator class, a Bucket class, a BucketNode class, a ExperimentBucket class, a BucketsList class, a Experiment class, a ExperimentBuilder class, a DynamicExperimentService class and/or a FileExperimentBuilder class.

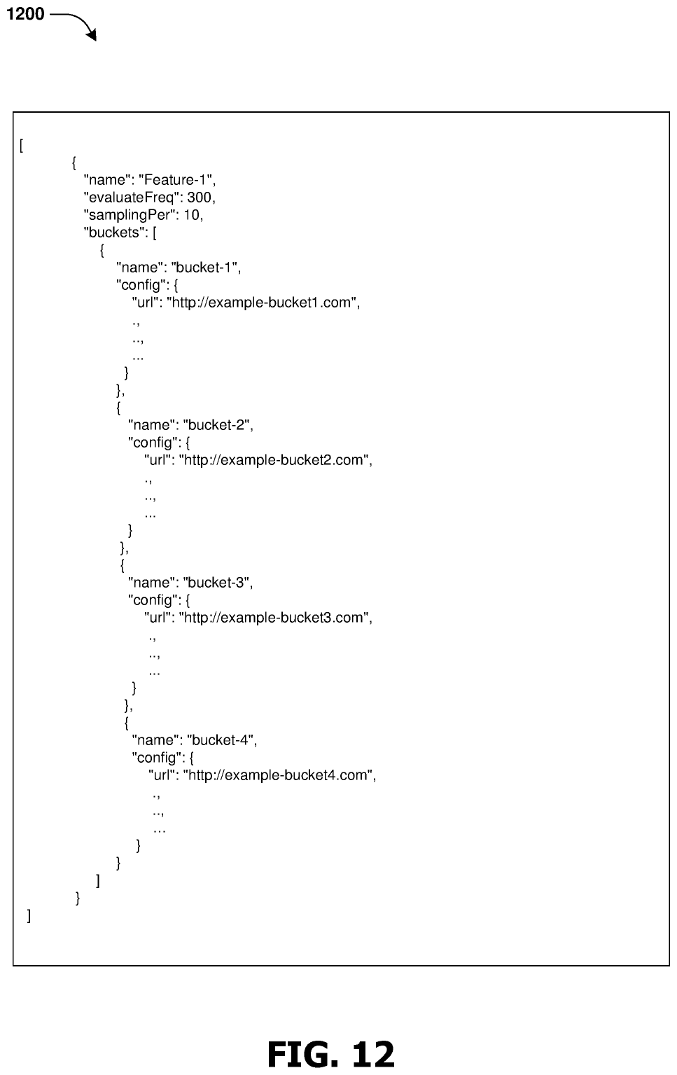

FIG. 12 illustrates example code 1200 of a computer program used to perform one or more of the techniques herein. In some examples, the example code 1200 may be provided in JSON format. In some examples, executing the example code 1200 causes the bucketing system to (i) configure four buckets for an optimization process (e.g., the feature-1 optimization process 866 in FIG. 8B), (ii) set the evaluation frequency associated with the feature-1 optimization process 866 to five minutes (e.g., 300 seconds), and/or (iii) set the experimental sampling proportion associated with the feature-1 optimization process 866 to 10%. In some examples, initially (e.g., in an initial evaluation period of the feature-1 optimization process 866), processes (e.g., web traffic) may be distributed among the four buckets in approximately equal parts. After the initial evaluation period (e.g., after the initial five minutes of the feature-1 optimization process 866 running), the bucketing system may evaluate the four buckets and/or select a winning bucket to be the production bucket (for a subsequent evaluation period, for example). In some examples, after selecting the winning bucket to be the production bucket, the bucketing system may assign processes amounting to about 10% of processes (e.g., 10% of web traffic) of the subsequent evaluation period to experiment buckets of the four buckets (e.g., some or all of the four buckets). In some examples, a set of processes amounting to about 90% of the processes (e.g., 90% of web traffic) of the subsequent evaluation period may be assigned to the production bucket (e.g., the winning bucket). In some examples, the processes assigned to the experiment buckets may comprise an initial batch of processes (e.g., an initial batch of web traffic) of the subsequent evaluation period, wherein the initial batch of processes (i) may amount to about 10% of the processes (e.g., 10% of web traffic) of the subsequent evaluation period, and/or (ii) may be assigned to the experiment buckets before the set of processes (amounting to about 90% of the processes of the subsequent evaluation period) is assigned to the production bucket.

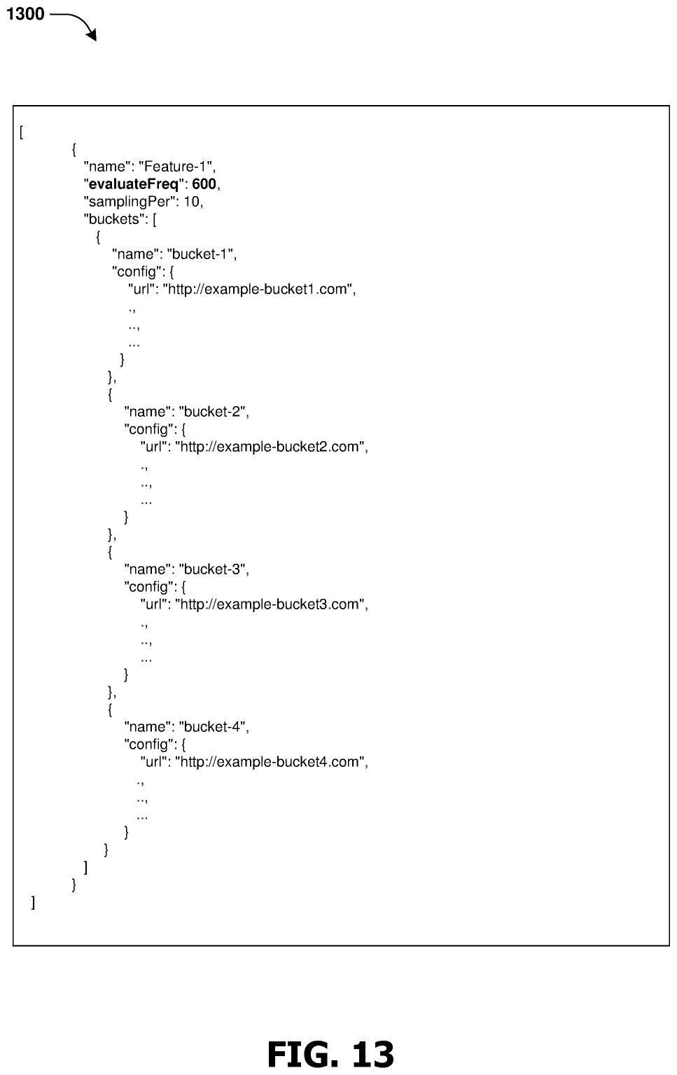

FIG. 13 illustrates example code 1300 of a computer program used to perform one or more of the techniques herein. In some examples, the example code 1300 may be provided in JSON format. In some examples, executing the example code 1300 causes the bucketing system to (i) configure four buckets for an optimization process (e.g., the feature-1 optimization process 866 in FIG. 8B), (ii) set the evaluation frequency associated with the feature-1 optimization process 866 to ten minutes (e.g., 600 seconds), and/or (iii) set the experimental sampling proportion associated with the feature-1 optimization process 866 to 10%.

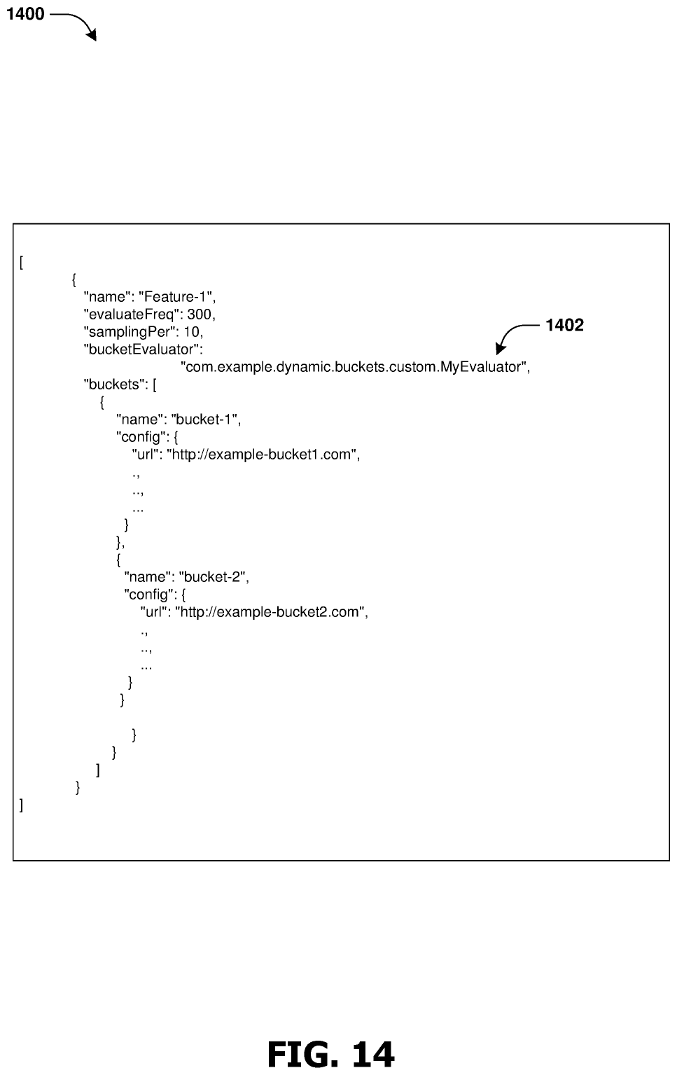

FIG. 14 illustrates example code 1400 of a computer program used to perform one or more of the techniques herein. In some examples, the example code 1400 may be provided in JSON format. In some examples, executing the example code 1400 causes the bucketing system to (i) configure two buckets for an optimization process (e.g., the feature-1 optimization process 866 in FIG. 8B), (ii) set the evaluation frequency associated with the feature-1 optimization process 866 to five minutes (e.g., 300 seconds), and/or (iii) set the experimental sampling proportion associated with the feature-1 optimization process 866 to 10%. In some examples, the example code 1400 provides a performance evaluation class 1402 (e.g., a custom performance evaluation class), which may be used as the bucket evaluator 876 in FIG. 8B.

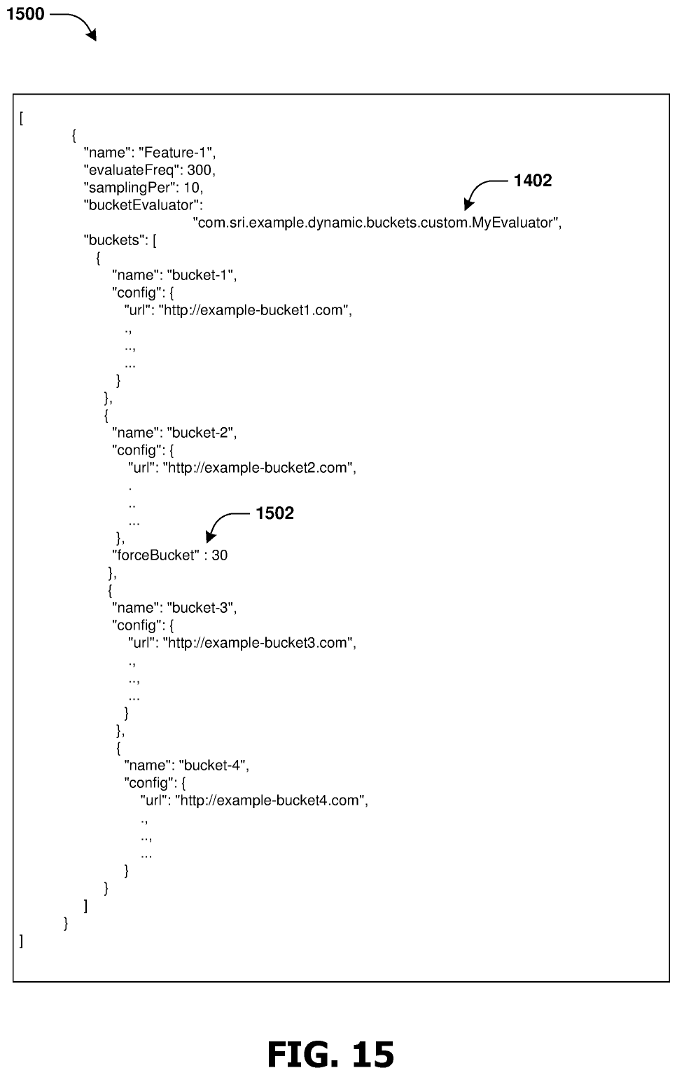

FIG. 15 illustrates example code 1500 of a computer program used to perform one or more of the techniques herein. In some examples, the example code 1500 may be provided in JSON format. In some examples, executing the example code 1500 causes the bucketing system to (i) configure four buckets for an optimization process (e.g., the feature-1 optimization process 866 in FIG. 8B), (ii) set the evaluation frequency associated with the feature-1 optimization process 866 to five minutes (e.g., 300 seconds), and/or (iii) set the experimental sampling proportion associated with the feature-1 optimization process 866 to 10%. In some examples, the example code 1400 provides the performance evaluation class 1402, and/or an instruction 1502 to assign at least 30% of processes (e.g., at least 30% of web traffic) to bucket-3 (regardless of how bucket-3 performs, for example). In some examples, the bucketing system may assign an initial batch of processes (e.g., an initial batch of web traffic) of an evaluation period to bucket-3, wherein the initial batch of processes may amount to about 30% of the processes (e.g., 30% of web traffic) of the evaluation period. After assigning the initial batch of processes (e.g., about 30% of the processes of the evaluation period) to bucket-3, the bucketing system may distribute a second batch of processes (e.g., a second batch of web traffic) of the evaluation period in approximately equal parts among the four buckets, wherein the second batch of processes may amount to about 10% of the processes (e.g., 10% of web traffic) of the evaluation period. After distributing the second batch of processes (e.g., about 10% of the processes of the evaluation period) among the four buckets, the bucketing system may assign a third (e.g., remaining) batch of processes (e.g., a third and/or remaining batch of web traffic) of the evaluation period, wherein the second batch of processes may amount to about 60% of the processes (e.g., 60% of web traffic) of the evaluation period.

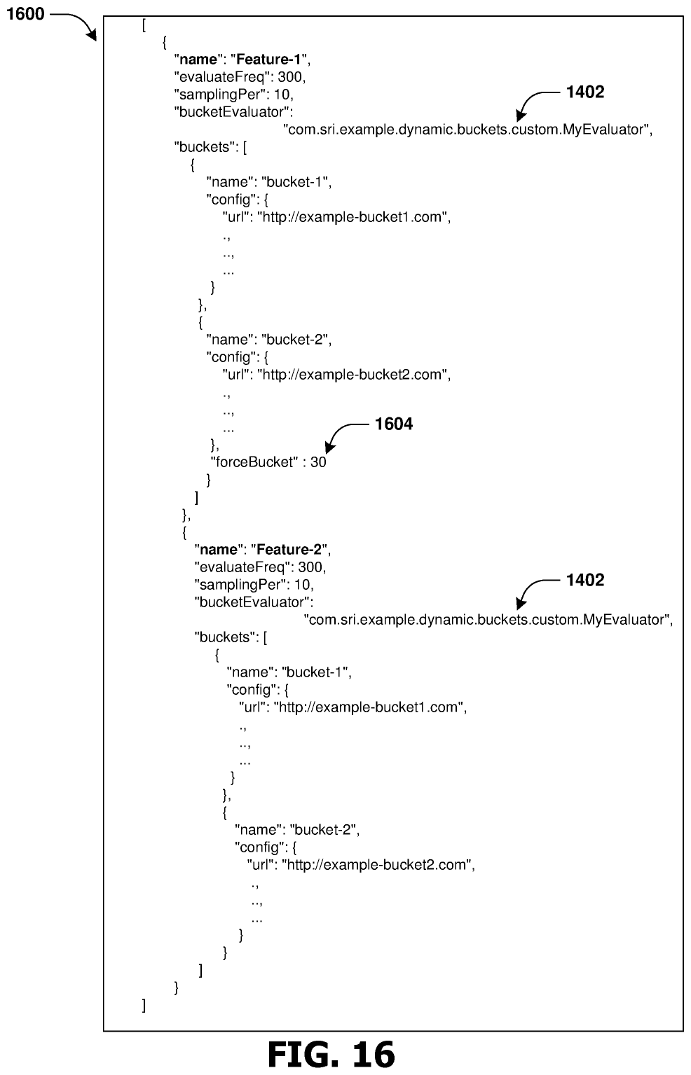

FIG. 16 illustrates example code 1600 of a computer program used to perform one or more of the techniques herein. In some examples, the example code 1600 may be provided in JSON format. In some examples, executing the example code 1600 causes the bucketing system to (i) for each of two optimization processes (e.g., the feature-1 optimization process 866 and/or the feature-2 optimization process 868 in FIG. 8B), configure two buckets for the optimization process, (ii) set the evaluation frequency for each of the optimization processes to five minutes (e.g., 300 seconds), and/or (iii) set the experimental sampling proportion associated with each of the optimization processes to 10%. In some examples, the example code 1400 provides the performance evaluation class 1402 for each of the optimization processes, so as the performance evaluation class 1402 be used as the bucket evaluator 876 in FIG. 8B for both of the optimization processes. In some examples, for the feature-1 optimization process 866, the example code 1400 provides an instruction 1604 to assign at least 30% of processes (e.g., at least 30% of web traffic) to bucket-2 (regardless of how bucket-3 performs, for example).

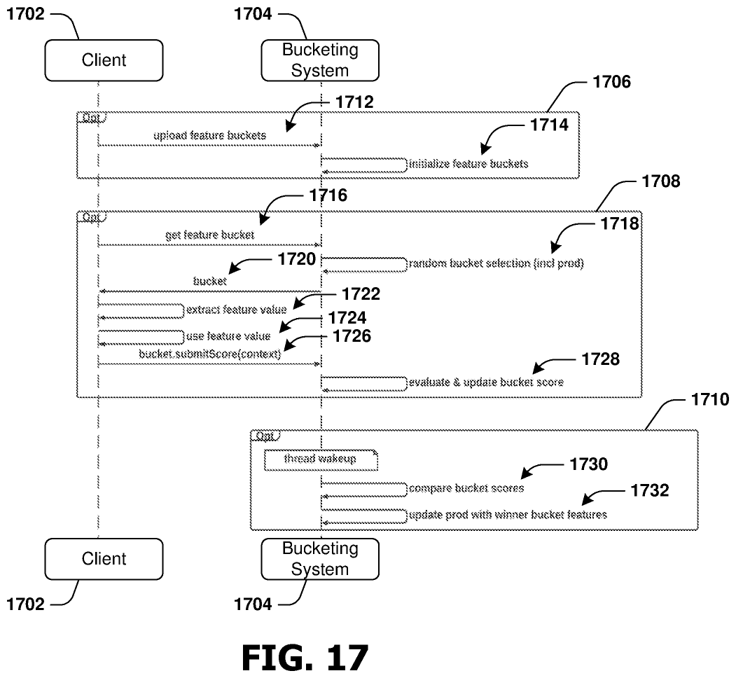

FIG. 17 illustrates example flow diagrams (e.g., sequence diagrams) associated with interactions between a client 1702 and the bucketing system (shown with reference number 1704). Temporal relationships shown in FIG. 17 are exemplary. A first act that is shown and/or described as being performed after a second act in FIG. 17 may be performed before the second act in some embodiments. In some examples, the client 1702 may correspond to the first application (discussed with respect to FIGS. 5A-5E, for example), the content system (discussed with respect to FIGS. 6A-6D, for example), and/or the client 802 (discussed with respect to FIGS. 8A-8B, for example). The example flow diagrams may comprise (i) a startup flow diagram 1706 associated with initializing a fifth optimization process for one or more fifth features associated with the client 1702, (ii) a bucket assignment flow diagram 1708, and/or (iii) a background thread flow diagram 1710.

In some examples, the client 1702 may provide 1712 the bucketing system 1704 (e.g., a dynamic bucketing system) with a plurality of buckets (and/or a bucket configuration of the plurality of buckets) to the bucketing system 1704, which may initialize 1714 the plurality of buckets (according to the bucket configuration, for example). In some examples, the client 1702 may trigger 1716 the bucketing system 1704 to provide a bucket of the plurality of buckets for a process. In some examples, the bucketing system 1704 selects 1718 a bucket 1720 (via random bucket selection and/or based upon one or more configured target proportions) and/or provides the bucket 1720 to the client 1702. In some examples, the client 1702 may extract 1722 a profile (e.g., a feature value and/or configuration) associated with the bucket 1720, and/or may use 1724 the profile to perform the process. In some examples, the client 1702 may submit one or more results 1726 (e.g., feedback, a bucket score, a process score, a delay time, etc.) associated with the process and/or the bucket 1720 to the bucketing system 1704. The bucketing system 1704 may evaluate 1728 the one or more results 1726 and/or one or more other results to determine and/or update bucket scores of the plurality of buckets. In some examples, the bucketing system 1704 may (i) compare 1730 bucket scores of the plurality of buckets with each other to identify a winning bucket, and/or (ii) update 1732 the production bucket based upon the winning bucket (e.g., the production bucket may be updated periodically according to an evaluation frequency associated with the fifth optimization process).

In some examples, at least some of the disclosed subject matter may be implemented on a client device, and in some examples, at least some of the disclosed subject matter may be implemented on a server (e.g., hosting a service accessible via a network, such as the Internet).

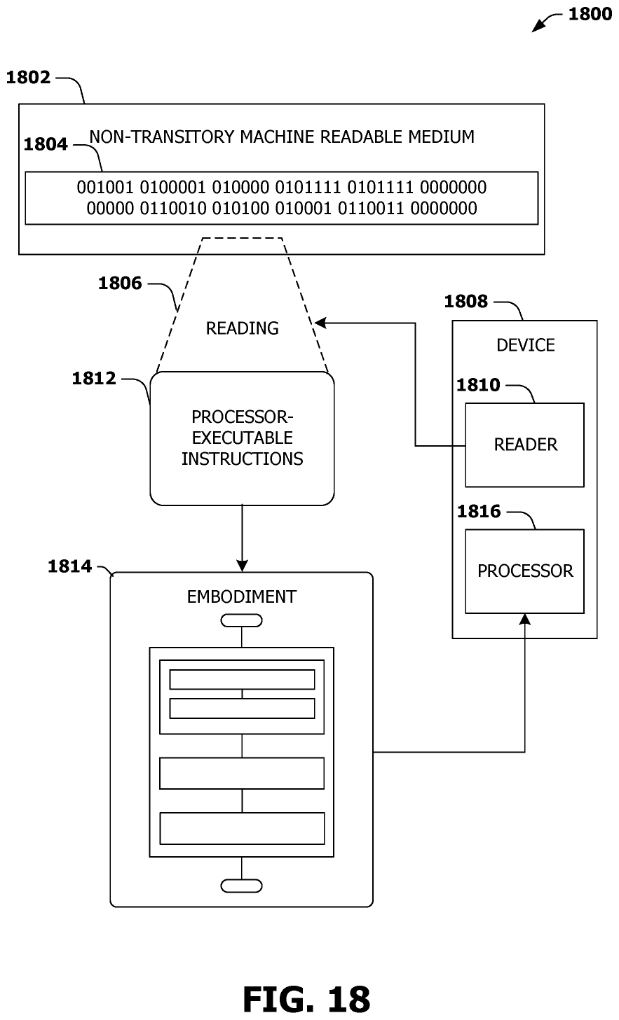

FIG. 18 is an illustration of a scenario 1800 involving an example non-transitory machine readable medium 1802. The non-transitory machine readable medium 1802 may comprise processor-executable instructions 1812 that when executed by a processor 1816 cause performance (e.g., by the processor 1816) of at least some of the provisions herein (e.g., embodiment 1814). The non-transitory machine readable medium 1802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 1802 stores computer-readable data 1804 that, when subjected to reading 1806 by a reader 1810 of a device 1808 (e.g., a read head of a hard disk drive, or a read operation invoked on a solid-state storage device), express the processor-executable instructions 1812. In some embodiments, the processor-executable instructions 1812, when executed, cause performance of operations, such as at least some of the example method 400 of FIG. 4, for example. In some embodiments, the processor-executable instructions 1812 are configured to cause implementation of a system, such as at least some of the example system 501 of FIGS. 5A-5E, the example system 601 of FIGS. 6A-6D, the example system 701 of FIGS. 7A-7B, and/or the example system 801 of FIGS. 8A-8B, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
configuring a plurality of buckets comprising:
a first bucket associated with a first profile;
a second bucket associated with a second profile; and
a third bucket associated with a third profile;
assigning a first plurality of content item requests to the first bucket;
performing first processes associated with the first plurality of content item requests according to the first profile associated with the first bucket;
assigning a second plurality of content item requests to the second bucket;
performing second processes associated with the second plurality of content item requests according to the second profile associated with the second bucket;
determining, based upon the first processes and the second processes, evaluation metrics associated with the first bucket and the second bucket;
selecting the first bucket based upon the evaluation metrics; and
in response to selecting the first bucket, modifying the third profile associated with the third bucket based upon the first profile associated with the first bucket.

2. The method of claim 1, wherein:
the first profile is indicative of a first timeout value;
a process of the first processes comprises transmitting a first content item request of the first plurality of content item requests to a first content item server, wherein the first content item request is indicative of the first timeout value;
the second profile is indicative of a second timeout value; and
a process of the second processes comprises transmitting a second content item request of the second plurality of content item requests to a second content item server, wherein the second content item request is indicative of the second timeout value.

3. The method of claim 2, wherein:
modifying the third profile based upon the first profile comprises modifying, based upon the first timeout value indicated by the first profile, a third timeout value indicated by the third profile to a modified timeout value.

4. The method of claim 3, wherein:
the modified timeout value is equal to the first timeout value.

5. The method of claim 3, comprising:
after modifying the third profile based upon the first profile, at least two of:
assigning a fourth plurality of content item requests to the first bucket and performing fourth processes associated with the fourth plurality of content item requests according to the first timeout value indicated by the first profile associated with the first bucket;
assigning a fifth plurality of content item requests to the second bucket and performing fifth processes associated with the fifth plurality of content item requests according to the second timeout value indicated by the second profile associated with the second bucket; or
assigning a sixth plurality of content item requests to the third bucket and performing sixth processes associated with the sixth plurality of content item requests according to the modified timeout value indicated by the third profile associated with the third bucket.

6. The method of claim 5, comprising:
after modifying the third profile based upon the first profile:
determining second evaluation metrics associated with the second bucket and at least one of the first bucket or the third bucket based upon the fifth processes and at least one of:
the fourth processes; or
the sixth processes;
selecting the second bucket based upon the second evaluation metrics; and
in response to selecting the second bucket, modifying, based upon the second timeout value indicated by the second profile, the modified timeout value to a second modified timeout value.

7. The method of claim 1, wherein the evaluation metrics comprise at least one of:
a first response latency metric associated with reception of one or more responses to one or more content item requests of the first plurality of content item requests;
a first measure of responses associated with the first plurality of content item requests;
a second response latency metric associated with reception of one or more responses to one or more content item requests of the second plurality of content item requests; or
a second measure of responses associated with the second plurality of content item requests.

8. The method of claim 7, comprising:
determining a first score associated with the first bucket based upon at least one of the first response latency metric or the first measure of responses; and
determining a second score associated with the second bucket based upon at least one of the second response latency metric or the second measure of responses, wherein the first bucket is selected based upon the first score exceeding the second score.

9. The method of claim 1, wherein:
configuring the plurality of buckets comprises:
configuring the first bucket with a first target proportion of requests; and
configuring the second bucket with a second target proportion of requests;
assigning the first plurality of content item requests to the first bucket is performed according to the first target proportion of requests; and
assigning the second plurality of content item requests to the second bucket is performed according to the second target proportion of requests.

10. A computing device comprising:
a processor; and
memory comprising processor-executable instructions that when executed by the processor cause performance of operations, the operations comprising:
configuring a plurality of buckets comprising:
a first bucket associated with a first profile;
a second bucket associated with a second profile; and
a third bucket associated with a third profile;
assigning a first plurality of processes to the first bucket;
performing the first plurality of processes according to the first profile associated with the first bucket;
assigning a second plurality of processes to the second bucket; performing the second plurality of processes according to the second profile associated with the second bucket;
determining, based upon the first plurality of processes and the second plurality of processes, evaluation metrics associated with the first bucket and the second bucket;
selecting the first bucket based upon the evaluation metrics; and
in response to selecting the first bucket, modifying the third profile associated with the third bucket based upon the first profile associated with the first bucket.

11. The computing device of claim 10, wherein:
the first profile is indicative of one or more first video streaming parameters;
a process of the first plurality of processes comprises providing a first video stream to a first client device according to the one or more first video streaming parameters;
the second profile is indicative of one or more second video streaming parameters; and
a process of the second plurality of processes comprises providing a second video stream to a second client device according to the one or more second video streaming parameters.

12. The computing device of claim 11, wherein:
modifying the third profile based upon the first profile comprises modifying, based upon the one or more first video streaming parameters indicated by the first profile, one or more third video streaming parameters indicated by the third profile to one or more modified video streaming parameters.

13. The computing device of claim 12, wherein:
the one or more first video streaming parameters comprise at least one of a first video resolution or a first bit rate; and
the one or more modified video streaming parameters comprise at least one of a video resolution equal to the first video resolution or a bit rate equal to the first bit rate.

14. The computing device of claim 12, the operations comprising:
after modifying the third profile based upon the first profile, at least two of:
assigning a fourth plurality of processes to the first bucket and performing the fourth plurality of processes according to the one or more first video streaming parameters indicated by the first profile associated with the first bucket;
assigning a fifth plurality of processes to the second bucket and performing the fifth plurality of processes according to the one or more second video streaming parameters indicated by the second profile associated with the second bucket; or
assigning a sixth plurality of processes to the third bucket and performing the sixth plurality of processes according to the one or more modified video streaming parameters indicated by the third profile associated with the third bucket.

15. The computing device of claim 14, the operations comprising:
after modifying the third profile based upon the first profile:
determining, second evaluation metrics associated with the second bucket and at least one of the first bucket or the third bucket based upon the fifth plurality of processes and at least one of:
the fourth plurality of processes; or
the sixth plurality of processes;
selecting the second bucket based upon the second evaluation metrics; and
in response to selecting the second bucket, modifying, based upon the one or more second video streaming parameters indicated by the second profile, the one or more modified video streaming parameters to one or more second modified video streaming parameters.

16. The computing device of claim 10, wherein:
configuring the plurality of buckets comprises:
configuring the first bucket with a first target proportion of processes; and
configuring the second bucket with a second target proportion of processes;
assigning the first plurality of processes to the first bucket is performed according to the first target proportion of processes; and
assigning the second plurality of processes to the second bucket is performed according to the second target proportion of processes.

17. A non-transitory machine readable medium having stored thereon processor-executable instructions that when executed cause performance of operations, the operations comprising:
configuring a plurality of buckets comprising:
a first bucket associated with a first profile; and
a second bucket associated with a second profile;
assigning a first plurality of processes of a first evaluation period to the first bucket;
performing the first plurality of processes according to the first profile associated with the first bucket;
assigning a second plurality of processes of the first evaluation period to the second bucket;
performing the second plurality of processes according to the second profile associated with the second bucket;
determining, based upon the first plurality of processes and the second plurality of processes, evaluation metrics associated with the first bucket and the second bucket; and
based upon the evaluation metrics, selecting the first bucket to be a production bucket during a second evaluation period following the first evaluation period.

18. The non-transitory machine readable medium of claim 17, wherein:
configuring the plurality of buckets is performed using a bucket configuration indicative of:
a first target proportion of processes for the production bucket of the plurality of buckets; and
one or more second target proportions of processes for one or more buckets, of the plurality of buckets, other than the production bucket; and
the operations comprise:
assigning, according to the first target proportion of processes, a third plurality of processes of the second evaluation period to the first bucket;
performing the third plurality of processes according to the first profile associated with the first bucket;
assigning, according to a target proportion of the one or more second target proportions of processes, a fourth plurality of processes of the second evaluation period to the second bucket;
performing the fourth plurality of processes according to the second profile associated with the second bucket;
determining, based upon the third plurality of processes and the fourth plurality of processes, second evaluation metrics associated with the first bucket and the second bucket; and
based upon the second evaluation metrics, selecting the second bucket to be the production bucket during a third evaluation period following the second evaluation period.

19. The non-transitory machine readable medium of claim 18, the operations comprising:
assigning, according to a target proportion of the one or more second target proportions of processes, a fifth plurality of processes of the third evaluation period to the first bucket;
performing the fifth plurality of processes according to the first profile associated with the first bucket;
assigning, according to the first target proportion of processes, a sixth plurality of processes of the third evaluation period to the second bucket;
performing the sixth plurality of processes according to the second profile associated with the second bucket;
determining, based upon the fifth plurality of processes and the sixth plurality of processes, third evaluation metrics associated with the first bucket and the second bucket; and
based upon the third evaluation metrics, selecting the second bucket to be the production bucket during a fourth evaluation period following the third evaluation period.

20. The non-transitory machine readable medium of claim 18, wherein:
the first profile is indicative of one or more first video streaming parameters;
a process of the first plurality of processes comprises providing a first video stream to a first client device according to the one or more first video streaming parameters;
the second profile is indicative of one or more second video streaming parameters; and
a process of the second plurality of processes comprises providing a second video stream to a second client device according to the one or more second video streaming parameters.
